(19) United States
(12) Patent Application Publication
(10) Pub. No.: US 2006/0081031 A1
(43) Pub. Date: Apr. 20, 2006

(54) Medical coating test apparatus and method

(75) Inventors: Jonathan Dale Anderson, Chanhassen, MN (US); Glenn Toews, Eden Prairie, MN (US); Andrew Summerville, Minnetonka, MN (US)

Correspondence Address: Mr Glenn Toews;Harland Medical Systems, LLC, 7418 Washington Avenue South, Eden Prairie, MN, 55344, US

(73) Assignees: Jonathan Dale Anderson; Glenn Toews; Andrew Sommerville

(21) Appl. No.: 10/967,693

(22) Filed: Oct. 18, 2004

(51) Int. Cl. G01N 19/02; G01N 19/00

(52) U.S. Cl. 73/9; 73/150 R

(57) ABSTRACT

The present invention presents novel apparatus and methods to address the problem of measuring surface characteristics of a coated medical device. A preferred embodiment of the invention incorporates a processor-controlled transport module to move a test sample at a predetermined velocity profile past a variety of fixtures. The fixtures include a processor-based, feedback-controlled servo mechanism that applies an predetermined normal force on a test sample with selected test surfaces to measure dynamic friction, abrasion resistance and durability of a coating. More generally, the invention can be used to characterize surface and pull or push properties of a wide variety of objects that also include threads, filaments, rods, tubing, wires, extrusions, films and ribbons.

### CROSS REFERENCE TO OTHER APPLICATIONS

This application claims the benefit of U.S. Provisional Patent Application Ser. No. 60/510,227 filed on Oct. 10, 2003.

### BACKGROUND

### Field of the Invention

Medical devices, such as catheters, that access human and animal bodies, especially through the vasculature, must be able to be moved and placed easily and efficiently. These devices are continually improved by adding more complex functions and decreasing diameter. This enables devices to obtain access to more regions of the body and to smaller or more tortuous blood vessels. But problems are created when medical devices bind or adhere at bends in tortuous blood vessels or buckle. In addition, intravascular catheters can injure vascular endothelium and can dislodge material from vessel walls and create possibly dangerous emboli. Recently, numerous surface modification technologies, such as applied coatings, have been developed that can be applied to alter characteristics of many medical devices, for example to reduce friction (increase lubricity).

An apparatus and method are needed to make objective measurements of surface properties for research, development and verification testing of medical devices with treated or modified surfaces. Traditional test apparatus, particularly for measuring surface friction, are very limited in their capabilities. No apparatus can be operated vertically, provide arbitrary and variable frictional loads, or operate with both tension and compression. Further, no existing or proposed device accommodates testing devices from a controlled fluid bath.

The motivation behind the invention of the friction test system is the need for a consistent, repeatable, and comparable laboratory bench test well suited to medical devices and representing, as closely as feasible, the in vivo environment. Animal tests and other simulations of the ultimate in-vivo environment are expensive and suffer from a lack of repeatability.

In the first design of this invention, the inventors focused on tubular medical devices such as catheters. For this application, and considering the objectives, there are several major factors that affect the design. (1) The design must accommodate testing a reasonably large segment of a tubular medical device. (2) The constriction mechanism generating the normal force as a source of friction must be consistent throughout a test and across multiple tests. (3) The mechanism measuring the friction force must accurately and consistently measure the force and accommodate force measurement ranges consistent with multiple applications of medical devices. (4) The constriction mechanism must be sufficiently flexible to accommodate multiple test conditions representing the in-vivo environment as closely as possible. Among other capabilities it must accommodate a temperature controlled saline bath or other appropriate fluid or mixture to simulate the in-vivo environment. Furthermore, this simulated environment must maintain the integrity of the sample under test. (5) The design must facilitate consistent repeatability of a test without extensive sources of variation, including those due to different operators. (6) The design must facilitate the organization's testing procedures and methodologies. It must provide an easy-to-use user interface with a logical progression of steps from defining the actions in a test to monitoring the progress and results during a test to generating reports and protecting the integrity of the data. Also, it should accommodate defining the test and analyzing results on a computer remote from the test system itself. (7) The design must have low cost. (8) The design must provide for easy and reliable calibration, including to known and transferable standards.

### SUMMARY OF INVENTION

The apparatus and method of the present invention test the performance of coatings applied to medical devices, particularly intravascular catheters, tubing, lead wires, guide wires and other leaded devices. More generally, the invention can be used to characterize surface and pull or push properties of a wide variety of objects that also include threads, filaments, rods, tubing, wires, extrusions, films and ribbons. Other applications may use the test apparatus to measure or characterize tackiness, adhesion, abrasiveness and abrasion resistance of a surface.

### BRIEF DESCRIPTION OF DRAWINGS

FIG. 1 is an isometric view of the coating test apparatus comprising a control module, a transport tower with a housing covering the force transport drive mechanism, a force transport module, a clamp module, a fluid container and a test sample.

FIG. 2 is a partial assembly view of the force gauge module.

FIG. 2a are a partial assembly views of the force gauge module before and after loading to an overload limit.

FIG. 3 is an isometric view of the clamp module with the cover removed.

FIGS. 3a to 3c are isometric assembly views of the clamp module containing a force transducer and sensing plate.

FIG. 4 is an isometric rear view of the control module with the cover removed.

FIG. 5 is an isometric view of the front of the transport tower with the cover removed and showing a lead screw drive.

FIG. 5a is an isometric view of the rear of the transport tower with the cover removed and showing a v-groove wheeled carriage.

FIG. 5b is an isometric view of a belt drive transport and v-groove wheeled carriage.

FIGS. 6a and 6b are a functional block diagrams that illustrate the circuits, electrical components, power and signal/communication lines.

FIG. 7 is a block diagram of data, interface, storage and signal processing components, and communication lines.

FIG. 8 is a block diagram of the software execution threads and primary control loops.

FIG. 9 is a flow chart of the test process.

FIG. 10 is a flow block diagram of the test protocol structure.

FIG. 11 diagrams the user interface screen and control hierarchy.

FIG. 12(a-k) are illustrations of the user interface screens for the test apparatus.

FIG. 13 is an isometric view of the clamp module with a calibration bracket and known mass in place.

FIG. 14(a-e) are illustrations of the user interface screens data viewer application.

### DETAILED DESCRIPTION

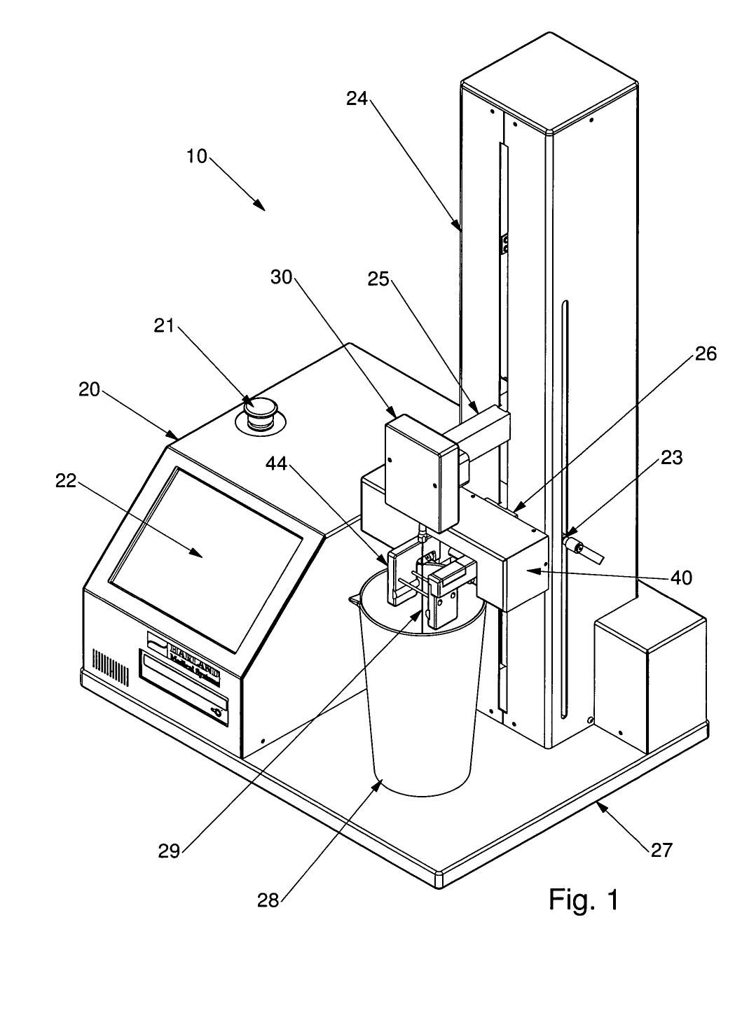

FIG. 1 illustrates an embodiment of a coating test apparatus 10. For convenience of description the apparatus can be considered to comprise four component modules. The control module 20 with a touch-sensitive user interface screen 22 and emergency stop button 21. The transport tower 24 with a force gauge module transport 25 and adjustable height mounting subsystem 23 for a clamp module mount 26. A force gauge module 30 and a loading device in the form of a clamp module 40 with clamp jaws 44 are shown attached to the respective module mounts 25 and 26 on the transport tower. A support base 27 is also illustrated to which the control module and transport tower are attached. Also illustrated is a container for a fluid 28, such as saline, which is placed on the support base and in which the test piece or sample 29 is immersed prior to being drawn through the clamp module by the force gauge module transport system.

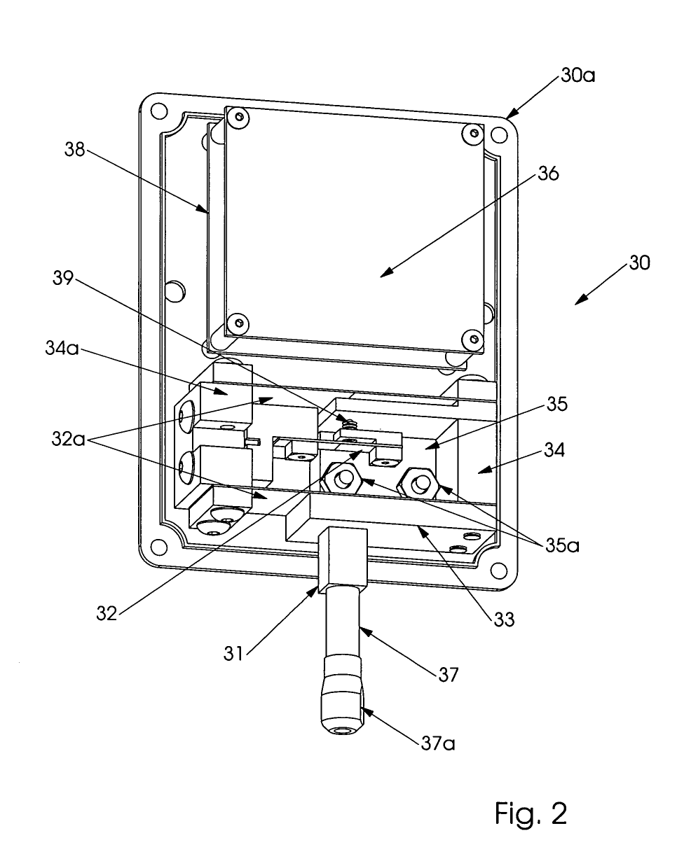

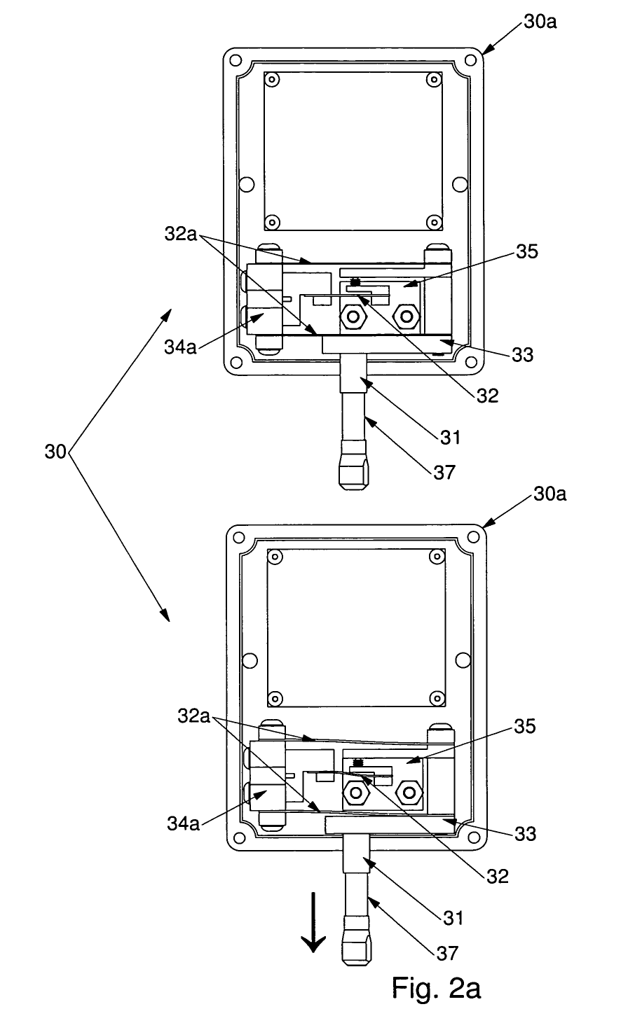

The transport tower is shown in a vertical orientation with the force gauge module 30 located directly above the clamp module 40. In this configuration the test sample 29 is clamped in a collet (37 and 37a of FIG. 2) of the force gauge module and is drawn from the fluid container 28 through the clamp jaws 44 by the transport. The vertical orientation, as illustrated, ensures that gravitational force acts only in the direction of motion and along the primary axis of elongated test samples. However, a horizontal orientation may be preferred for tests involving test samples that are either particularly heavy relative to the expected pull force and elastic strength of the test sample or that are particularly buoyant in the fluid. An enhanced version of the coating test apparatus would provide for the transport tower to be mounted to the support base with a rotation mechanism to enable both vertical and horizontal configurations.

The height of the transport tower is preferably more than twice as tall as the length of the test sample. For testing intravascular catheter sections the tower height is between 10 and 100 cm and preferably about 50 cm. The height of the transport tower must allow for testing of the full test segment length of the sample and simultaneously ensure that the fluid container is tall enough so that the sample does not touch the sides or bottom of the container. A similar requirement might apply in the horizontal configuration so that the entire length of the test sample test section can be withdrawn from a fluid container formed in the shape of a trough. A smaller ratio of transport tower height to test segment length may be used for test samples that do not need to be protected from contact with other materials or other portions of the test sample. This could be configured where a test sample to be tested dry is drawn, for example, from a spool. The height of the transport tower depends primarily on the article to be tested and may be from tens of cm to tens of meters.

The system design also contemplates a means to compensate for the increased load on the force gauge as more of the test sample is withdrawn from the fluid. One method of correction is to record force (weight) as a function of the amount of the test sample withdrawn from the fluid during a trial run when the clamp is not in contact with the test sample. This change in force relative to the starting force could be subtracted from the force recorded during a test run with the clamp in contact with the test sample. Alternatively, the buoyant weight per unit length of the test sample can be found from the force gauge as the difference in total weight while the test sample is freely suspended minus the weight when fully immersed divided by test sample length and then subtracted from measured force times distance moved of the force gauge during a test run. As another example, the relative densities of the test sample and fluid can be entered into a calculation incorporating static characteristics of the test sample.

A common purpose for medical coatings is to increase the lubricity (decrease dynamic friction) of a catheter or similar device. Many such coatings may be stored or processed under dry conditions but must be hydrated to impart lubricity. Therefore, the test sample must be immersed in an aqueous fluid, such as water or saline, prior to and while being tested. If the test sample is withdrawn from the fluid during a test cycle it must be returned to the fluid bath for rehydration before the next cycle, preferably with a pause between cycles to achieve complete rehydration. Other medical coating formulations require buffer or other solutions with specific compositions. In addition, certain tests may be intended to test factors such as the effect of surfactants on the coating by using a fluid such as an albumin suspension to immerse the test sample.

A further feature of the test apparatus are a heater and controller to maintain the temperature of the fluid bath through a series of tests. The heater will typically employ conduction from electric resistive heating elements, though other methods, such as radiant and inductive heating, may be employed. Resistive heating elements may be located under the fluid container, immersed in the fluid bath or wrapped around the fluid container. Generally, the fluid bath may be maintained at temperatures between 30° C. and 90° C. For medical applications the preferred temperature range will be between 35° C. and 42° C. Each of the exemplary heaters may be controlled by a specific power supply and local control circuit. The control circuit may be arranged to receive temperature setpoints, heating rates, maximum temperature and maximum power output commands from the device controller (SBC) in response to direct user inputs or settings entered in a test protocol.

Yet another feature of the test apparatus is a stirring mechanism to keep different fluid constituents of the fluid bath mixed or solid or semi-solid materials substantially uniformly suspended in the fluid. The stirring mechanism may further be employed to ensure a more uniform temperature distribution in a fluid bath that is being heated or cooled. Applicable stirring mechanisms include permanent magnet stir rods located within the fluid container and driven by a rotating magnet in the support base, an impeller immersed in the fluid bath and driven by a DC motor, or an ultrasonic mixer. Each of the exemplary stirring mechanisms may be controlled by a specific power supply and local control circuit. The control circuit may be arranged to receive stir rate setpoints, maximum rotational speeds and maximum power output commands from the SBC in response to direct user inputs or settings entered in a test protocol.

The support base provides a rigid structure to prevent motion of the transport tower and support the fluid container. The support base is preferably formed from a single piece of solid material such as steel or aluminum. Holes or other fastening features may be incorporated in the support base to allow it to be attached to a table, legs or other mounting structure. Non-slip or shock mountings may be attached to the support base to isolate the test apparatus from vibration and prevent slippage. Alternative configurations of the support base could incorporate a removable or adjustable platform beneath the force gauge and clamp modules to accommodate a wider variety or fluid containers or test samples. Yet another embodiment of the support base would allow the transport tower to swivel about the attachment point to the support base so that the force gauge and clamp modules are located past the edge of the support base and with a clear field to the floor.

FIG. 2 shows a design for the force gauge module 30 that includes a releasable mechanism to engage the force gauge mount on the transport tower (23 in FIG. 1), a collet 37 and 37a or other mechanism adapted to grasp the test sample, a force beam transducer 32, preload adjustment screw 39, an overload protection mechanism for the force beam transducer consisting of a spacer block 34 suspended from mounting block 34a by leaf springs 32a and a stop block 35, fixed or adjustable attachments 35a for stop block 35, excitation and amplifier circuit 36, the data acquisition, data storage and forwarding I²C circuits 38 for the force transducer, and connectors to establish power and signal communications through the transport tower mount (not shown).

The mechanism to grasp the test sample will typically be a collet-type device for catheters, guide wires and similar elongated articles with a circular cross-section. But other devices are contemplated to accommodate a wide variety of test articles. As an example, a larger, hollow tube-like article may not be sufficiently rigid to be grasped by compression from the exterior and must be held by two or more arms expanded from inside the article. Also contemplated are luer fittings, screw threads and clamps, an adjustable pin vice or hooks.

An important point in the design of the grasping mechanism is that it be free to swing in directions orthogonal to the sense axis (load direction) of the force transducer. This ensures free movement while minimizing twisting or bending forces on the force sensor. At the same time, the connection between the grasping mechanism and force transducer must be sufficiently stiff to accommodate the entire load applied during a test without stretching or other deformation.

Because the connection between the grasping mechanism and force transducer is free to move in transverse directions a means must be provided to limit swinging motion of the grasping mechanism. Unimpeded swinging induced by such as external forces (shocks and vibrations, air currents, etc) or discontinuities in the motion of the force transducer module will impair accurate force measurement. A slot is formed in the force transducer module cover (not shown) that cooperates with flat surfaces 31 on the grasping device mounting arm 33 to limit both swing and twisting motion without applying a load on the force transducer.

The force transducer 32 illustrated in FIG. 2 is a bending beam type transducer such as the series TBS sensors manufactured by Transducer Techniques, Inc. This type of transducer has strain sensors attached to a relatively flexible metal strip (the beam). It has the advantage of good sensitivity and repeatability at reasonable cost. However, other transducers, such as piezo, strain gauge and MEMS transducers that are stiffer, have greater range or provide better overload protection may also be provided in different versions of the force transducer module.

In one preferred embodiment of the apparatus used to test intravascular devices the user may select different force transducer modules with ranges of 0 to 250 g, 0 to 450 g or 0 to 1500 g. In general, the force transducer module will be provided in a range appropriate for the intended test samples and capabilities of the transport tower. These ranges can be from as low as 0 to 20 g to as high as 0 to 10 kg. Accuracy of the force transducer should be better than ±0.5% full scale and preferably better than ±0.2% full scale.

Also illustrated in FIG. 2 is an overload protection mechanism where an arm on spacer block 34 cooperates with stop block 35 incorporated into the force transducer module. Force transducers 32, such as bending beam transducers, undergo substantial elastic strain when loaded. This permits great sensitivity but has the tradeoff of low overload capacity. Excessive forces may easily be encountered when a test sample is loaded into the grasping mechanism or when the device is operated inappropriately, such as when the grasping mechanism 37 is mistakenly trapped in the clamp jaws 44. The two views of the force transducer module in FIG. 2a further illustrate the function of the overload protection mechanism. The top panel in FIG. 2a shows the unloaded configuration of the force gauge module and the lower panel in the module loaded to the protection limit. The sample holder mounting arm 33 is attached to two, horizontally-oriented flat springs 32a cantilevered from mounting block 34a through spacer block 34. An extension from the mounting arm is coupled to the bending beam transducer 32 with an adjustable screw 39. The adjustable screw transfers force from the mounting arm to the bending beam transducer. The adjustable screw is set at the time of manufacture to control the bending beam range of motion with respect to the mounting arm. Protection against overload is provided by a stop block 35 attached to the force transducer module back plate 30a. The risk of overloading the force transducer is limited when the springs or mounting arm encounter the stop block and are prevented from further movement.

The force transducer module, as illustrated in FIG. 2, comprises an excitation and amplifier circuit 36 for the force transducer. The circuit may be either an OEM device, such as the model TM0-1-24 VDC by Transducer Techniques, Inc. or be custom-made for use in the test apparatus. The circuit provides a stabilized excitation voltage or current, depending on the type of transducer, bridge circuit completion components and a low-noise operational amplifier.

An analog to digital conversion (ADC) and I²C communications circuit 38 is preferably located close to the force transducer excitation and amplifier circuit 36. Close proximity to the excitation and amplifier circuit minimizes noise in the transducer signal. The digital force transducer signal is transported on the I²C communications bus 203 in packets, each with checksum values to ensure maximum integrity of the force measurements. An alternative preferred embodiment of the force transducer module combines the separate functions of the ADC and communications circuit with the excitation and amplifier circuit in a single circuit located on a single circuit board in close proximity to the force transducer.

The ADC and communications circuit for the pull force module of the present invention also optionally contains a specialized EEPROM (model 24C65 by Microchip Technology, Inc) 206 that can store the identification, characteristics and calibration of the specific force transducer incorporated into a module. Additionally, the clamp module ADC and communications circuit 42a of the present invention also optionally contains a specialized EEPROM (model 24C65 by Microchip Technology, Inc) 207 that can store the identification, characteristics and calibration of the specific clamp force transducer incorporated into a clamp module 40. The data contained in the EEPROM memory is automatically read by the I²C communication network 203 and provided to the single-board computer (SBC) 100. The identification information is recorded by the computer for purposes of traceability when the test apparatus is used for validated tests. The transducer characteristics and calibration data enable the computer to record force with maximum accuracy while requiring minimal or no calibration or data entry by the operator for each force transducer module.

A further purpose of the EEPROM memory circuit is to ensure that force and clamp modules are properly connected to their respective mount on the transport by verifying that data stored in the EEPROM can be read by the ADC and communications circuit. The ADC and communications circuit may pass data read from the EEPROM to the SBC where a check can be made that the installed module is compatible with the test apparatus and that the calibration of the module is current.

Great care was taken to limit electrical noise in the force transducer signal by electrical filtering of the excitation power, electrical shielding and by mounting the digital conversion (ADC) and I²C communications circuit and excitation and amplifier circuit as closely as possible to the force transducer (measures that also apply to the clamp force transducer). Nevertheless, added digital filters were found to be effective at improving the signal-to-noise ratio. One method is a median method in which the system utilizes the median sample from a sample set as the stored value. Another method is a hybrid of median and averaging which eliminates the minimum and maximum values from a sample set and averages the remaining median values. Another hybrid median and averaging method is one in which the two highest and two lowest values of a sample set are eliminated and the average of the remaining values is stored. Another method closely approximates the median of an array of values in which the number of elements in the array is a power of three. The algorithm splits the array into three sets, the medians of which are calculated and used in successive median calculation iterations until there are no values remaining. Another possible filter is a low pass filter utilizing the following formula: Stored Sample=((1/N*Acquired Data)+(1−(1/N))*Last Stored Data), where N is preferably a value between 2 and 32. The preferred filter, such as the low pass filter described above, would be small and efficient enough to be executed in the ADC and I²C communications circuit.

Both the force transducer and clamp transducer analog signals must be converted to digital representations for processing and storage. A first-stage data acquisition rate of at least 20 kHz, and preferably at least 60 kHz, can provide adequate resolution for digital filtering and other processing. After one or more processing steps the digital data may be stored as samples having an effective rate (or resolution) of at least 100 Hz and preferably at least 250 Hz. Higher or lower acquisition and sample rates may be appropriate for respective smaller or larger versions of the test apparatus.

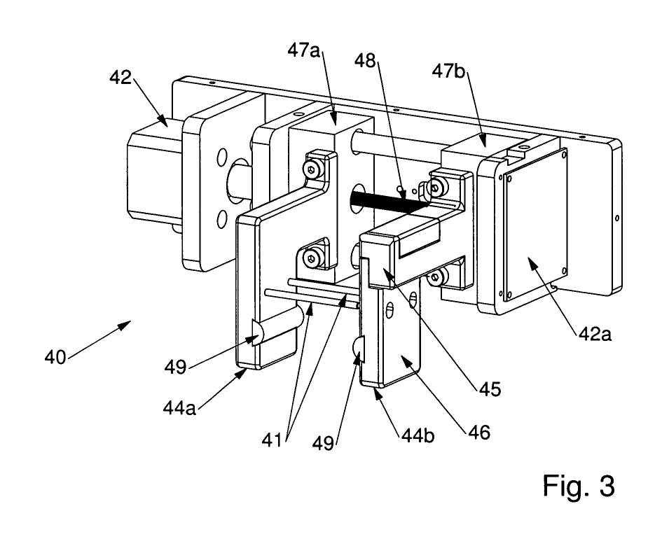

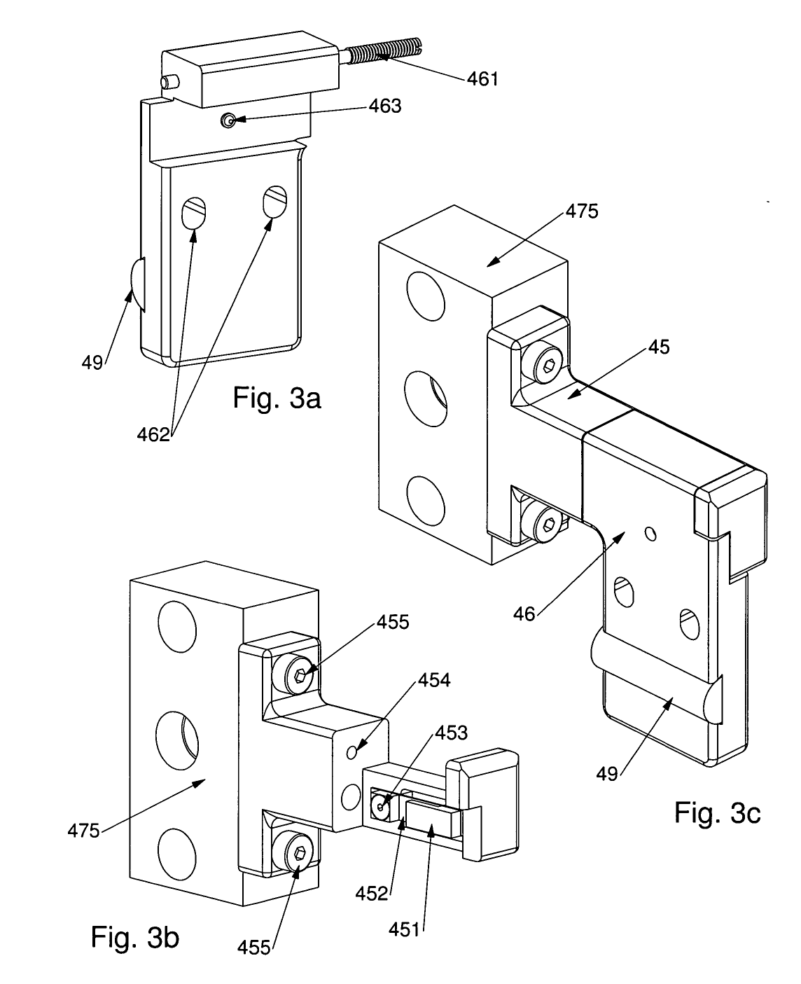

FIGS. 3 and 3a to 3c are a representative embodiment of a clamp module 40 comprising a motorized constriction mechanism 42, pads 49 to contact the test sample attached to two clamping jaws 44a and 44b, and a mounting mechanism with an incorporated electrical supply (not shown), communications circuit and excitation and amplifier circuit 42a and data connector. At least one of the clamping jaws 44b comprises a base plate 45 mounted rigidly to the clamp module via block 475 with screws 455 and a sense plate 46 rotatably mounted to the base plate by a hinge pin 461 threaded into opening 454. A clamp force transducer 452 is mounted with screw 453 between the plates 45 and 46 and measures force applied to the sense plate 46 as the jaws are brought into contact with the test sample. The set screw 463 transfers force from the sense plate to the clamp force transducer. The adjustable screw is set at the time of manufacture to control the clamp force transducer range of motion with respect to the sense plate. Registration pins 41 extend from the clamping jaw 44a through holes 462 provided in the sensing clamping jaw 44b to receive the registration pins. The registration pins are guides to keep the test sample centered in the clamping region of the base plate and sensing plate.

The constriction mechanism consists of two carriages 47a and 47b mounted on opposing sections of a threaded rod 48. The rod is driven by a stepper or servo motor 42 under feedback control by the clamp module stepper drive. Activation of the stepper motor and threaded rod to rotate in one direction causes the carriages, with attached clamping jaws, to move together, ultimately to a closed position. While rotation of the threaded rod in the other direction causes the carriages to move apart.

The clamping jaws extend wholly or partially below the bottom edge of the rest of the clamp module. This facilitates a preferred configuration of the test apparatus whereby the portion of the pads in contact with the test sample are immersed in the fluid bath along with the test sample. This helps to ensure that the test sample is completely wetted by the fluid throughout the tests and without effect by the speed at which the test sample is withdrawn from the fluid. Alternative configurations of the clamping jaws out of the fluid are contemplated for dry test samples and test samples from which excess fluid must be removed as they are drawn between the pads.

The clamping jaws in the present embodiment are fabricated of approximately 1 to 2 cm thick aluminum to effectively resist bending when in contact with the test sample. This ensures that the jaws are sufficiently rigid to contact only the test sample, and not each other. It also ensures that a specific portion of the jaw, generally the most sensitive region or calibrated centroid of the clamping force transducer sense jaw 44b, comes into closest contact with the test sample.

The clamp module stepper drive of the present embodiment is controlled by both general motion commands from the SBC and a local control loop with the force sensor. The SBC commands include open, close, home (generally to a specific force value) and halt. The local control loop is designed to operate quickly to maintain a constant transverse force on the test sample trapped between the jaws.

Registration pins keep the jaws aligned, add rigidity to the structure and aid in keeping the test sample positioned between the pads while the jaws are closed and while allowing the operator to keep clear. In one preferred embodiment the registration pins pass from through the holes in the sense jaw even at maximum separation of the two jaws. Alternatively, the registration pins may engage the holes in the sense jaw only when the jaws are in relative proximity, preferably within 50% or less of the maximum separation, to accommodate the dimensions of the fluid container or other limits.

A representative clamp force transducer is a model TM0-1-24 VDC by Transducer Techniques, Inc. with a range of 0 to 1000 g. In general, the clamp transducer will be provided in ranges appropriate for the intended test samples and capabilities of the transport tower. These ranges can be from as low as 0 to 250 g to as high as 0 to 10 kg with a preferred range of 0 to 500 g for intravascular medical devices. Accuracy of the clamp transducer should be better than ±5% and preferably better than ±2%.

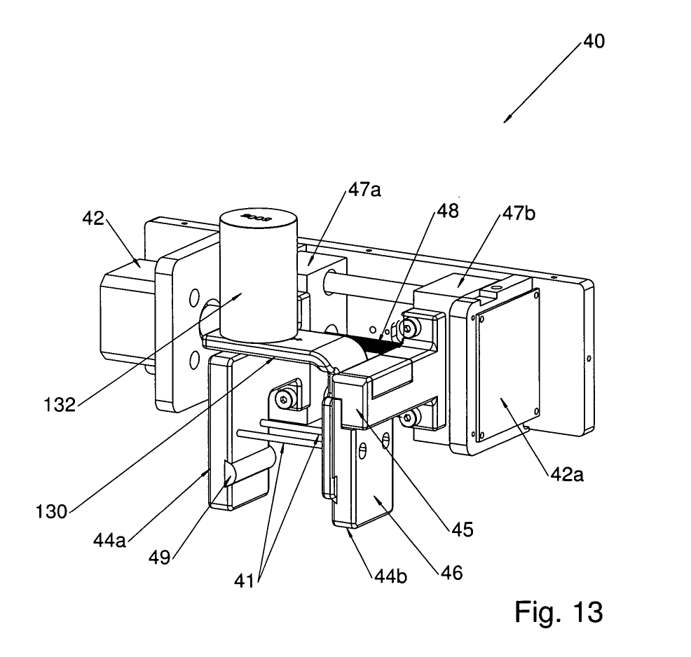

Referring now to FIG. 13, the clamp force transducer may be calibrated using a calibration bracket 130 mounted on the sense clamp jaw 46. The bracket has a 90° bend so that a horizontal segment is provided relative to the vertical segment that is attached to the clamp jaw. A known, calibrated mass 132 is placed on the horizontal segment the same distance horizontally from the sense clamp jaw hinge pin 461 as the force transducer is located vertically relative to the hinge pin. In this way the lever arms are equal and the same force applied on the calibration bracket by gravity from mass 132 is applied to the force transducer.

The clamp force transducer may also be calibrated by providing a swivel in the clamp mount or some other means of rotating the clamp module by 90°. A 90° rotation allows the sense clamp jaw 46 to be positioned horizontally. In the horizontal position a calibrated reference weight may be placed directly on the clamp jaw allowing the force sensor to be calibrated to a traceable standard. The weight is preferably positioned at a marked centroid on the clamp jaw that is then used as the primary point of contact with the test sample.

Referring again to FIG. 3, pads may be attached to the both of the clamp jaws for providing contact with the test sample. The pads may be either permanently attached, or preferably easily removed and replaced with new pads. Removable pads may be attached with a moderate adhesive similar to that used on Post-It notes (by 3M Corporation), captured in a frame or between clips, or molded around the jaws of the clamp.

Resilient pads may be manufactured of a number of materials including synthetic rubber (polybutadiene, butyl rubber, EPDM, neoprene, silicone rubber and acrylonitrile), natural fibers (cotton or wool), and synthetic fibers or films (rayon, polyethylene, Dacron and Goretex).

A primary function of resilient pads is to conform, at least partially, to the shape of the test sample. This achieves a greater percentage or degree of contact around the test sample and provides a more efficient test of a coating. The efficiency of a greater contact surface is gained, in part, by requiring less clamp force to produce frictional force and because more of the fluid adhered to the surface of the test sample can be removed as it leaves the fluid bath.

Pads with greater stiffness (less resilience) may be needed for certain test samples, such as those that are relatively flat, including ribbons and films. Such pads may be formed of metals and metal alloys (steel, stainless steel, molybdenum, or gold), ceramics and crystals (sapphire, silicon dioxide, AlGaAs) and polymers (delron, polycarbonate, polypropylene, high density polyethylene). In addition, specialized tests, such as for abrasion resistance and wear, may be performed with test samples pulled through abrasive pads comprising materials such as carborundum, clay and silicone dioxide particles. Such abrasive pads would be useful for measuring rates of wear. Further, clamps formed of a specific material may be used in direct contact with a test sample, without the addition of pads.

For many tests a particular pad material may be chosen specifically to determine a wet or dry coefficient of friction with a specific test sample material. The present invention may be configured to perform efficient and repeatable measurements of friction coefficients needed for material selection and design.

A groove, channel or other feature may be formed in the surface of resilient or stiff pads or directly in the surface of the clamp jaws to increase contact area with the test sample. These features would also help to ensure that the clamping force is more uniformly distributed around the surface of the test sample. To achieve efficient and more uniform contact with the test sample features formed in the clamp surface should preferably be the same dimension or slightly smaller (to create an interference fit) than the test sample.

The purpose of the clamp module is to create a controllable level of friction force with a test sample to oppose the force applied by the motion of the force module. Other devices may also be employed to achieve the same purpose and may be attached to the clamp module mount. Types of alternative frictional devices include tortuous paths and annuli.

Several types of tortuous path devices are possible. One of the simplest is a horizontal cylinder. An elongate test sample may be wrapped around the cylinder a one or more times to provide a specific contact surface area. The test sample may be wrapped into grooves formed onto the surface of the cylinder to further increase contact area and help retain the test sample in place. The cylinder may be immersed in a fluid container or a stream of fluid may be directed across the cylinder for testing wetted surfaces and coatings.

Other types of tortuous path devices may be devised to more closely resemble blood vessels where coated catheters and guide wires are deployed. Preferred examples of this class of devices consists of tubes formed into shapes with one or more planar curves or corners and tubes formed into helices. In all of these devices the tube diameter relative to the elongate test sample and the radii and number of curves or corners may be adjusted to control surface contact area frictional force. Generally, it will be preferred that the length of these tubular devices be much shorter than the length of the test sample. These tubular devices may be easily immersed in a fluid container for wetted tests and in this fashion may provide protection against the test sample contacting the sides of the fluid container.

Yet another frictional device can be formed of an annulus providing an interference or compression fit to an elongate test sample. One type of annulus device may be created for a test sample with circular cross-section by forming a round hole in a relatively rigid material, such as solid PTFE or delrin, that is between 2 and 10% smaller in diameter than the diameter of the test sample. Test samples with non-circular cross-section or with varying diameter may be accommodated by an annular device employing a hole formed in inflated or relative soft and resilient material that fills the inside of a hollow, rigid cylinder.

Catheters, guide wires and other intravascular medical devices treated with lubricious coatings are commonly deployed in blood vessels by percutaneous insertion into the blood vessel and then being advanced by pushing at the percutaneous entry point. An important purpose of a lubricious coating is to reduce the friction between the intravascular device and tissue so that the device does not fail by buckling as it is advanced. The present invention may also be operated in a push mode by lowering the test sample into the fluid bath through the clamp module or other frictional device. The force transducer will record buckling (column failure) as a sudden drop in force while the force module is descending.

To provide extensive tests of a test sample the force module transport may be programmed to both raise and lower the test sample during measurement in a single test cycle.

Abrasion testing intentionally subjects the coated surface frictional contact with to harder material to determine the effect on subsequent performance of the coated surface. In one method the test sample is drawn across or between pads of a material representing conditions of use, like surgical gauze or felt; or specifically abrasive media, such as rubber impregnated with abrasive particles like carbide or clay, sand paper or other synthetic materials such as fiberglass and glass-filled plastic. The present invention is well suited to abrasion testing by applying the abrasive material to the test sample with the feedback-controlled clamp module. Constant clamp force may be applied to the test sample during and abrasion test. Test cycles would then be run until a predetermined number of cycles are completed or until the pull force reaches a predetermined level or rate of increase or decrease. Alternatively, clamp force may be feedback controlled to produce a constant pull force until a predetermined number of cycles are completed or until the clamp force reaches a predetermined level.

Another application of the present invention provides for adhesion testing. One form of adhesion test is characterizing the strength of the interface between a substrate and coating. In an exemplary configuration a pad or other suitable material attached to a fixture on the invention is bonded to the surface of the coated device using an adhesive, such as pressure-sensitive cement or epoxy. Pull force is then recorded until the until the interface between the coating and substrate fails. The force data can be used as an absolute or relative adhesion force number. Adhesion tests often require a higher pull force capability from the force gauge and transport module. In important parameter to control in adhesion tests is the rate of increase of pull force.

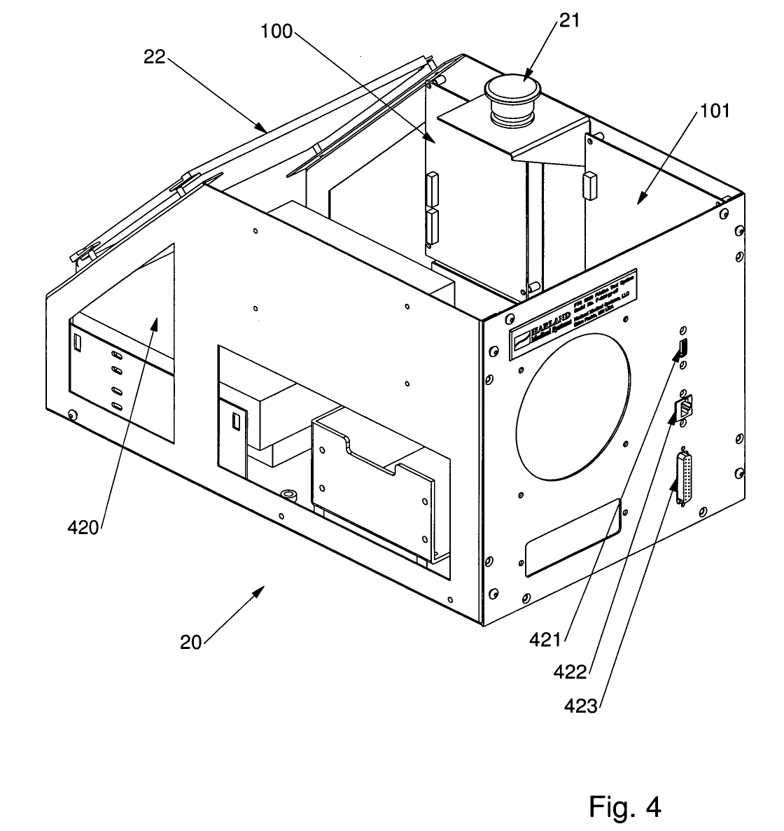

FIG. 4 illustrates a representative control module comprising touch-sensitive user interface screen 22, PC-type single-board computer (SBC, 786LCD3.5 by Kontron America, Inc or EBC3610F by BCM Advanced Research) 100 with interface ports 421,422,423, power supply, screen driver circuit, RS-232 to RS-485 interface circuit, I²C master controller circuit 101, hard disc drive, removable read-write storage device (CD-RW) 420, and an emergency stop button 21.

It will be easily understood by one skilled in the art that any or all of the control module components listed can be substituted with a variety of alternative or fewer components or subsystems that, in aggregate, provide the same functionality as the exemplary control module. For example, the functions of the SBC can be provided by a standard PC computer located within the control module housing or located external to the control module housing and communicating with the other components via a variety of wired and wireless interface channels such as USB 421, SCSI, PCI bus, Bluetooth, IEEE 802.11, or Ethernet 422. Similarly, the screen driver circuit functions may be split into separate power supply and screen driver/communication functions provided by an independent power supply and the SBC, respectively. Further, the RS-232 423, RS-485 and I²C communications may be substituted by a number of alternate bus and communication arrangements including those listed above for the PC computer. A wide variety of fixed and removable storage media may be substituted for the hard disc drive and CD-RW, including volatile and non-volatile memory circuits, USB memory drives, compact flash, DVD-R, and floppy disc. Storage may also be provided remotely, in whole or in part, by a logical or virtual means that communicates with the SBC via any number of the interface channels listed above.

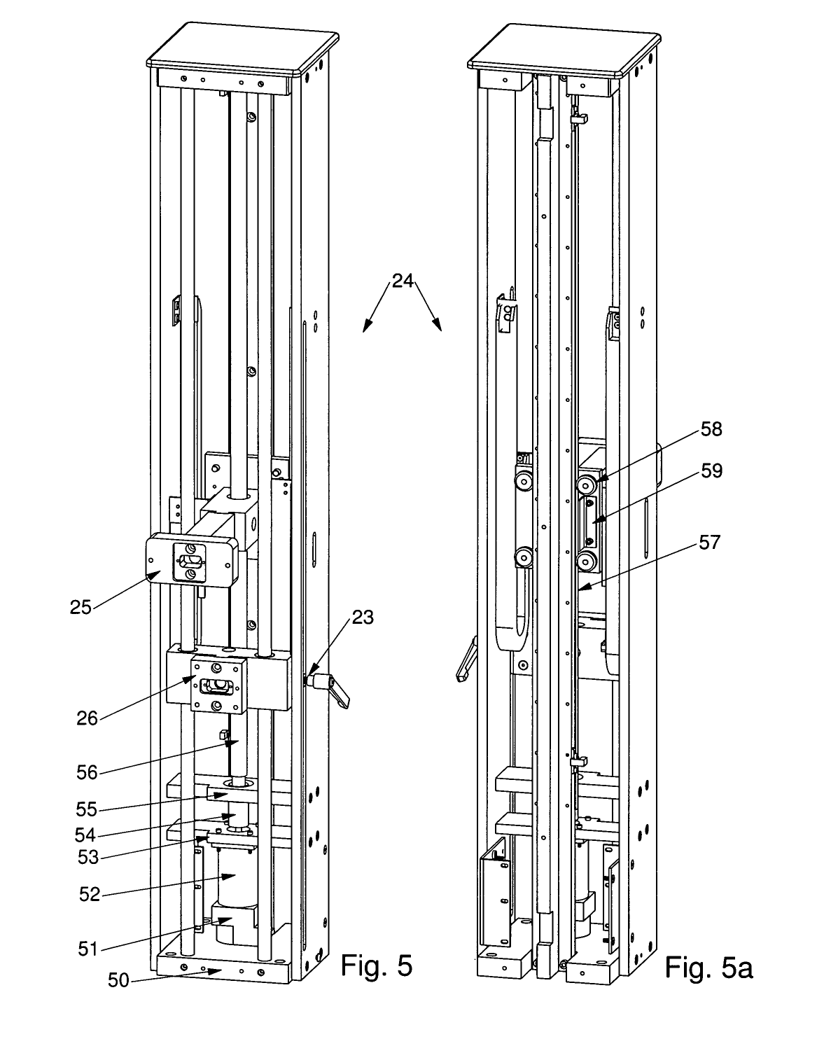

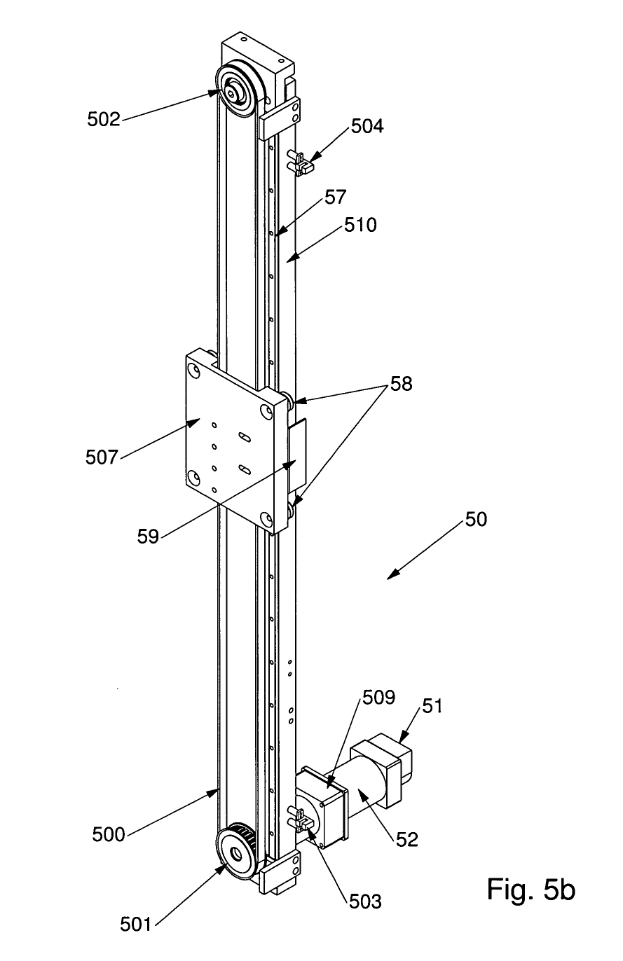

FIGS. 5, 5a and 5b shows details of the transport tower 24 comprising a rigid support structure that flexes minimally under loads. The tower provides the force gauge module transport subsystem and an adjustable height mounting subsystem for the clamp module. The tower may also contain excitation, amplifier, analog to digital conversion and data communication circuits for the force gauge and/or clamp modules.

A representative force transducer module transport subsystem comprises a lower mounting plate 50, stepper or servo motor 52, closed loop motor control circuits 51, data communication circuit, lead drive screw 56, lead screw to motor union 54, clamping module mount 26, force gauge transport 25, transport carriage 507 with grooved wheels 58 on rail 57, and top and bottom travel limit switches 503,504 activated by engagement with plate 59. The representative transport mechanism provides a preferable velocity range of 0.1 to 10 cm/s with a nominal velocity of 1.0 cm/s.

An alternative transport mechanism 50 illustrated in FIG. 5b employs a drive belt 500 driven by wheel 501 by motor 52 through gear set 509. One side of the drive belt is attached to carriage 507 and passes over idler wheel 502. Column 510 provides structural support to the wheels and drive mechanism.

The transport tower 24 also provides a clamping module mount 26 with a slot running vertically most of the height of the tower to allow fixing of the clamp module mount. The clamp module mount in the illustrated preferred embodiment is a manual screw device 23 to minimize weight and allow the operator to quickly set the proper height relative to the fluid container. For larger testers with heavier clamp mechanisms or conditions where it is impractical for the operator to adjust the clamp module mount by hand a motorized or automatic positioner will be preferred. However, any mechanism to adjust the position of the clamp module mount must achieve the same rigidity as the manual device.

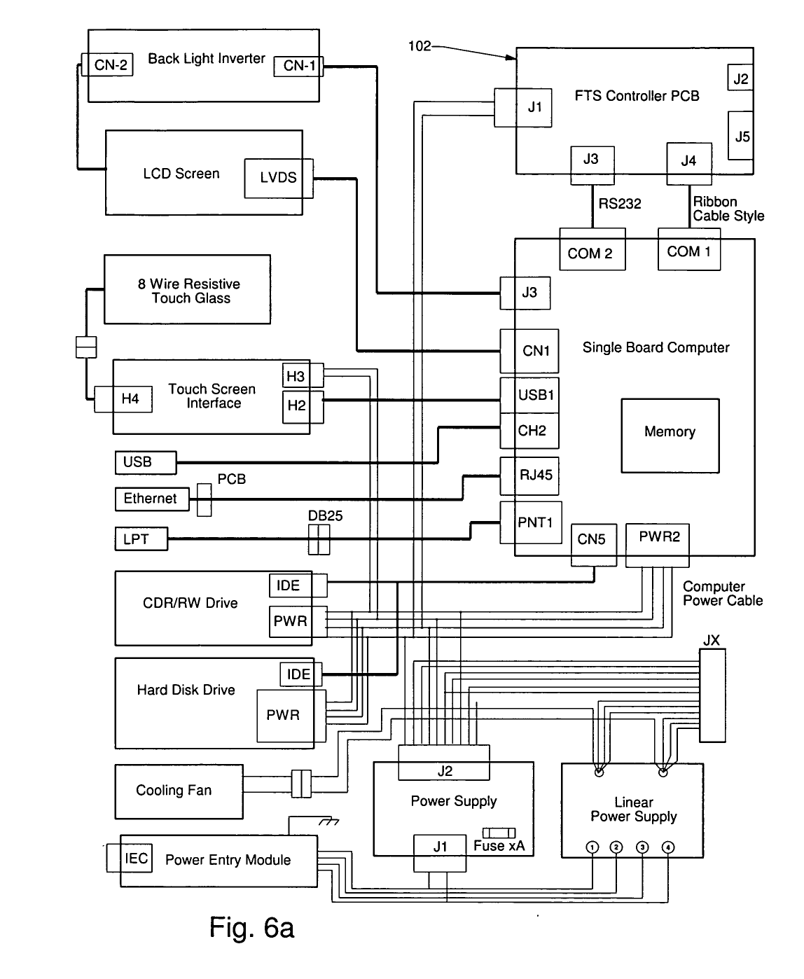

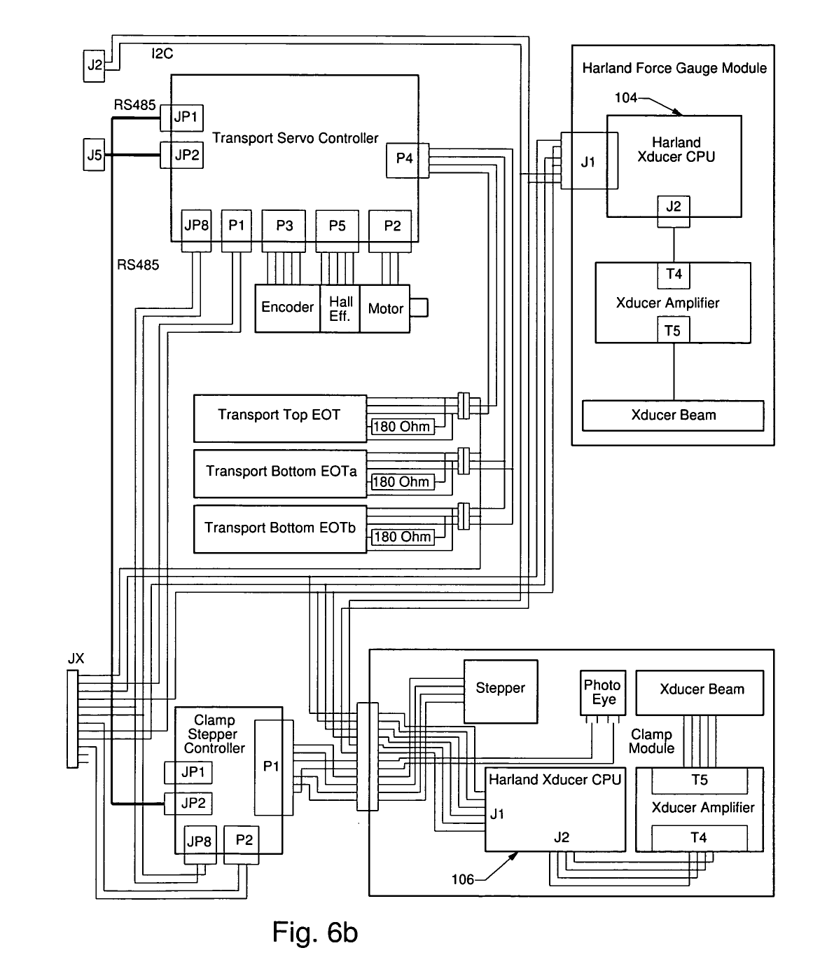

A detailed functional block diagram of a preferred configuration of the test apparatus is shown in FIGS. 6a and 6b with each of the electrically active components and their associated power and communication interconnections. Particular note should be made of the arrangement of the several custom subsystems that include the FTS control board 102, force transducer module transducer CPU circuit 104 and clamping module transducer CPU circuit 106.

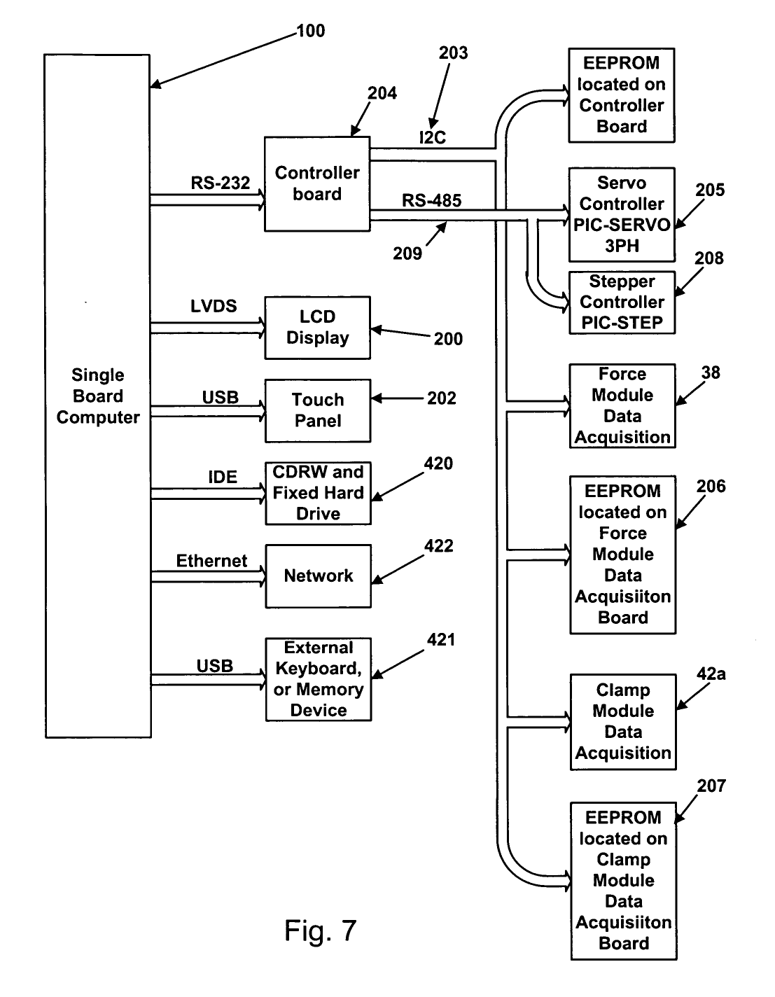

FIG. 7 shows one preferred configuration of subsystems and communications paths for the invention. The single board computer (SBC) 100 coordinates all the actions and mechanisms of the test apparatus while also managing the user interface comprising the LCD display 200 and touch panel 202. The SBC provides numerous data communication pathways including low voltage differential signaling (LVDS), universal serial bus (USB), Integrated Device Electronics (IDE), Ethernet, and RS-232. All of the listed communication paths are computer standard means that allow the SBC to interoperate with almost any computer peripheral device, including the illustrated user interface components, data storage devices 420, local and wide area networks 422, servo controller 205, non-volatile memory on data acquisition boards for the clamp 207 and force modules 206, and additional input devices. In the illustrated preferred embodiment of the invention an RS-485 serial communication path 209 is used to interface the controller board 204 with the transport tower servo controller 205 and stepper controller 208. For communication and control between the SBC and the motor controllers and limit sensors a RS-232 to RS-485 converter on the controller board 204 is used to provide a signal more robust to noise and interference. The controller board further communicates with the force transducer and clamp modules through an I²C bus 203 and with the emergency stop relay through an exclusive digital input/output (DIO) connection.

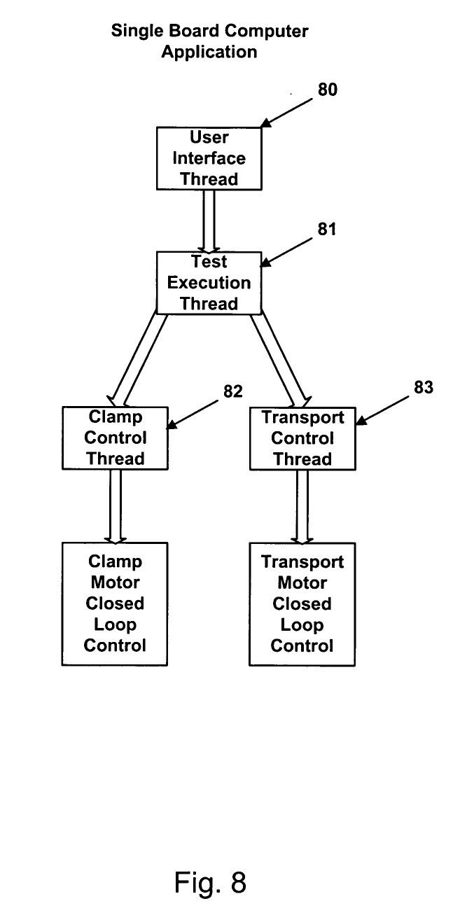

FIG. 8 illustrates a representative set of single board computer software application threads of execution. A user interface thread 80 provides the user interface and spawns a test execution thread 81 that controls the motion and data collection required to execute a test protocol. The test execution thread spawns a clamp control thread 82 for controlling and monitoring the clamp module motion and a transport control thread 83 for controlling and monitoring the transport motion.

The SBC provides for the master or higher level operation of the test apparatus. It can run various operating systems, including DOS, Windows, Linux, UNIX and any of several real-time operating systems, such as VxWorks, either alone or in combination. Software running on the SBC provides the primary operational control and enables communication with the user via the touch screen. The SBC also handles external communications for data storage and retrieval, and remote interfacing or control. The software running on the SBC of the exemplary apparatus employs four simultaneously and continuously operating threads to command and monitor operation of the test apparatus. These operating threads are shown graphically in FIG. 8 as the two higher level user interface and test execution threads. The test execution thread uses the transport control and clamp control threads.

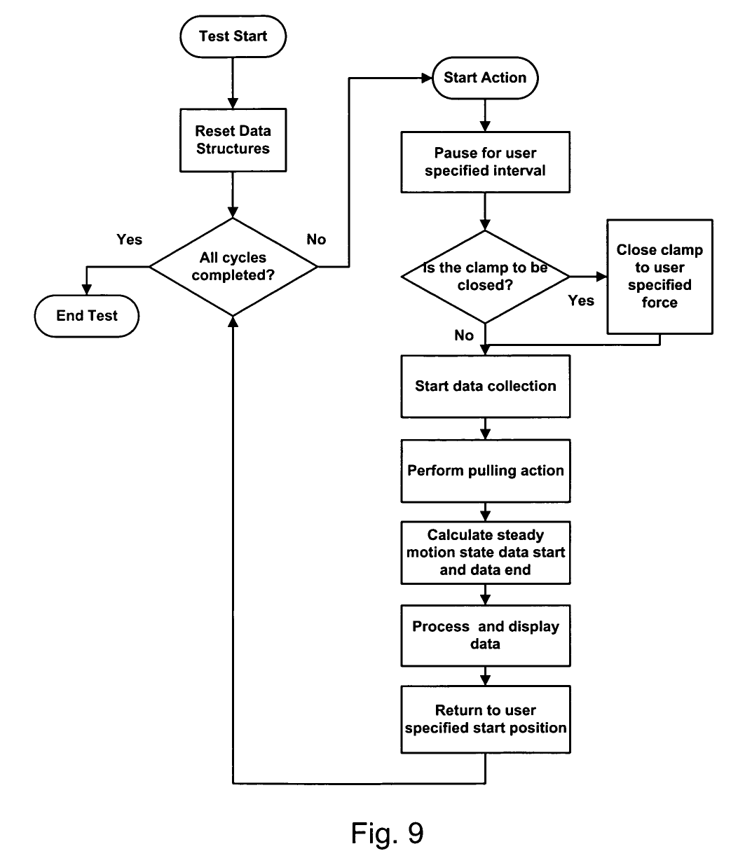

The process flow diagram in FIG. 9 describes the sequence of operations in the execution of a test protocol performed in a preferred embodiment of the present invention. The three outline shapes in the diagram help to represent entry points (oval), decision points (diamond) and actions (rectangle). When a test begins the data storage locations must be reset so that new data can not be combined with data from prior tests. From the data reset the SBC performs a check of whether all the test cycles in the protocol have been completed. A test protocol with no (zero) cycles would be improper and the test must be ended, but the test is made at this point to ensure that the program is not left in an undefined condition after a mistake by the operator. If test cycles remain in the protocol the SBC commands the test apparatus to execute the next cycle sequence.

To begin a test a fluid container is placed on the support base and positioned directly below the clamp jaws. Appropriate clamp pads are attached to the clamp jaws and the clamp module is positioned so that the pads are immersed in the fluid. The force module transport is then positioned at a convenient height, above the clamp module that allows the test sample to be attached to the force transducer while avoiding contact of other portions of the test sample with the test apparatus. The force module transport may be conveniently moved to the top of the transport tower by pushing the Max Up Fast button from the Test Station Setup screen.

The force transducer and test sample are then lowered to the start position with the test sample and clamp jaws immersed in the fluid bath using the Jog Down button, making sure that the fluid container is positioned so that the test sample does not contact the sides or bottom. Once the test sample is positioned vertically the clamp jaws are closed automatically to an applied nominal force of, for example, 1 g by pressing the Closed button on the Test Station Setup screen. The clamp jaws will close to a separation of approximately 1 to 2 cm, or preferably to within 0.5 cm of the known diameter of the test sample, at a first, higher, speed and then completes the close movement at a second speed that is between 10 and 20 times slower than the first speed until the clamp force transducer reaches the predetermined nominal force. While the clamp jaws are closing to contact with the test sample the operator observes, and may adjust, the test sample location so that it is properly positioned within the pads on the clamp jaws.

Once the pads on the clamp jaws are in contact with the test sample the operator can initiate a test protocol as either a ‘start from here’ or with the force module transport moving to a predetermined vertical position before the test begins.

The stop buttons on the screen or the emergency stop button on the control module may be use to halt actions by the test apparatus any time the force module transport or clamp jaws become malpositioned, or there is a pinch hazard or if some other fault occurs.

A variable pause in the sequence allows for processing of data and also allows the operator to confirm that the test apparatus is in the proper configuration for the next cycle. Pauses may be made at the end of a test cycle and/or after the force module and clamp are returned to their cycle start position. In an alternative embodiment to setting a single pause duration the pause may be programmable for a variety of purposes such as allowing a test sample to be immersed in the fluid bath long enough to saturate with the solution or to allow unwanted motion of the test sample or some portion of the test apparatus to decay. In yet another embodiment the pause may be made to require a keypress or other action by the operator for the next cycle to begin. This may be used, for example, to give the operator time to record data, confirm the condition of the test sample or to make some manual intervention in the test process.

Following a pause the test apparatus prepares for the next cycle by returning the force transducer module transport to its start position and confirming that the clamp jaws are closed with the predetermined force applied to the test sample.

After confirming that the test sample is properly gripped by the clamp, the test apparatus begins the force transducer transport move. The force transducer transport accelerates at a predetermined rate to the target steady-state velocity. The force transducer transport continues to move at the steady-state velocity for a predetermined distance or time. During the steady-state velocity portion of the transport move it is important that the transport velocity be very carefully controlled, with a close tolerance to within ±1% and preferably to within ±0.5% of the predetermined velocity.

Once the prescribed steady-state transport move has been completed the force transducer transport slows at a predetermined rate to a complete stop.

At the completion of a test cycle all data are stored to a file within the test apparatus and/or to one or more external devices connected to the test apparatus. The test data are also processed to identify data recorded during the steady-state velocity portion of the transport move of the test cycle. The start of the steady-state portion can be calculated from the time the move began, the acceleration rate and the programmed steady-state velocity. The end of the steady-state portion is marked when the force transducer module transport begins to decelerate. The steady-state portion may also be determined by locating earliest and last series of one or more consecutive force or velocity data samples that are within a predetermined band around the programmed steady-state velocity.

The steady-state move data are processed further in one or more post-processing steps. Once processing of the data is complete the processed data are stored in concert with the unprocessed test data and are also displayed for review by the operator on the control module touch screen or in an application running on an external device. Graphical and non-graphical (as average, median, peak or other summarized values) data processed and displayed for the operator or included in a later report include pull force vs time, peak force per cycle, average steady-state force per cycle, average peak force (from the overall test protocol or single test cycles) and pull force vs time and/or cycle number.

Test data may be stored as both binary data containing a cyclic redundancy check (CRC) code to ensure validity and in a commonly available format such as comma-separated variable (CSV). The CSV file may be uploaded to another computer and accessed or processed further in applications such as Excel (Microsoft) or LabView (National Instruments). The binary data may be recalled for review, printing or display by software running on the test apparatus or specialized software running on an external computer. If the binary data file fails the CRC check when read or opened the operator is notified that the data may be invalid due to corruption, a read error or attempts to modify the data. In addition to the sample data, both binary and common format data files contain the date and time, operator information, test protocol name and test protocol parameters.

In the present embodiment the test process continues automatically through the programmed number of test cycles in the protocol until the protocol is completed. Following all test cycles final data processing is completed, protocol results are displayed for the operator and data files are written to storage media. However, the protocol may be ended in other ways than completing a predetermined number of cycles. For example, in a durability test, cycles can be repeated until the pull force reaches a fixed value or the force begins to rise or drop at a prescribed rate. Alternatively, cycles can be repeated until a test sample fails. It is also possible for the operator to run one or more manual cycles with data collection while observing the test sample for changes in a certain characteristic, such as removal of a certain portion or percentage of a coating that has been stained with an indicator chemical.

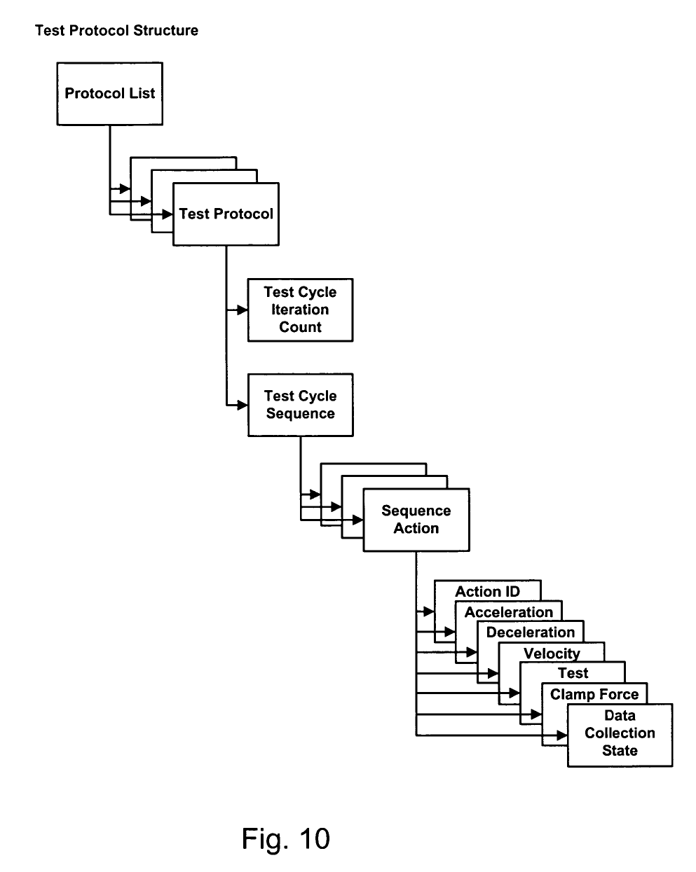

FIG. 10 provides a more detailed description of the organization and structure of test protocols for the coating apparatus. One or more test protocols can be created, uploaded to and stored within the apparatus. Stored protocols may be altered or new protocols created and stored to perform a variety of tests.

A preferred test protocol of the present invention is comprised of one or more test cycles. A preferred number of test cycles is between 5 and 20 for many catheters with a default value of 15 cycles in a Base Protocol. The test cycle, in turn, is comprised of one or more actions identified by an action ID. Each action is executed in sequence and may consist of settings for acceleration or deceleration, velocity, force transport move distance (test distance), clamp force and data collection state. A test cycle is complete when each of the programmed actions is completed and control is returned to the test protocol routine with an increment to the test cycle iteration count.

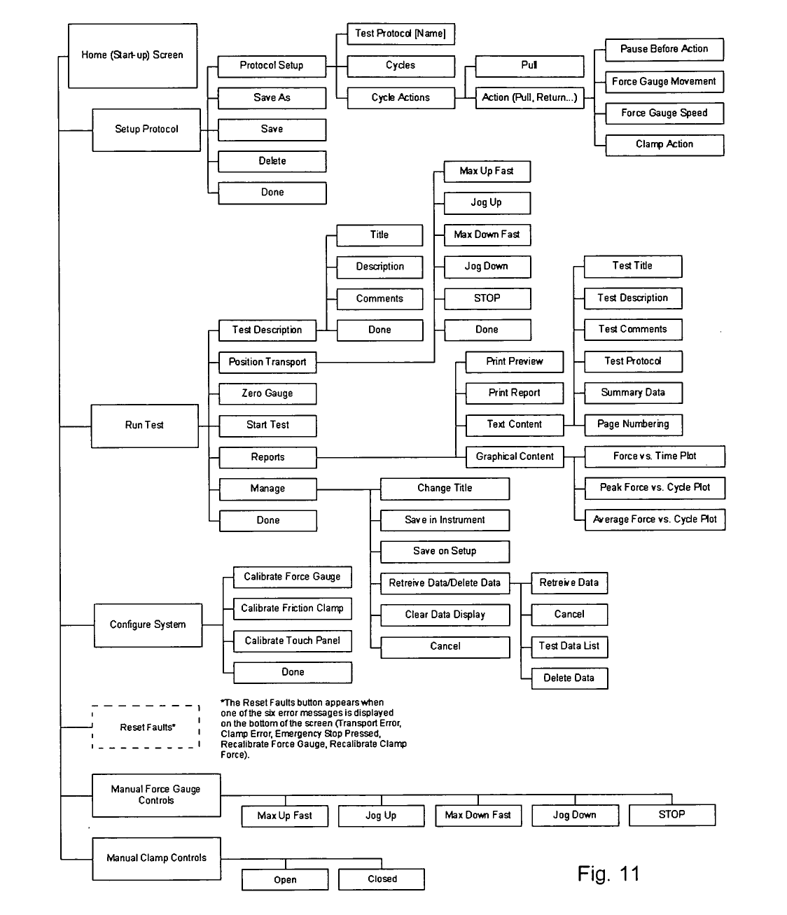

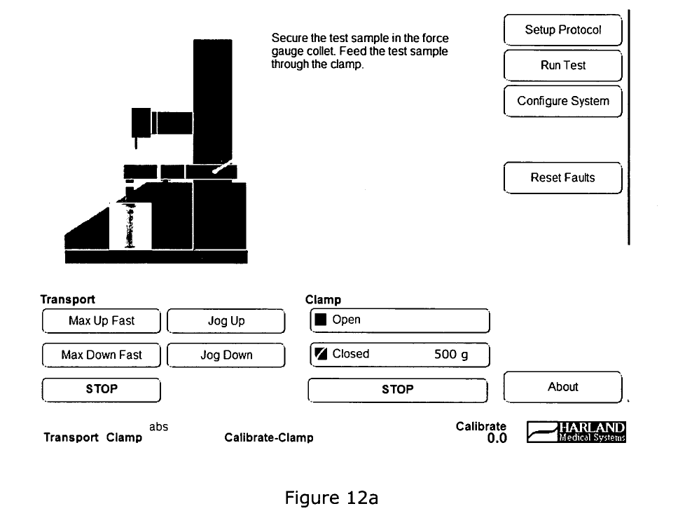

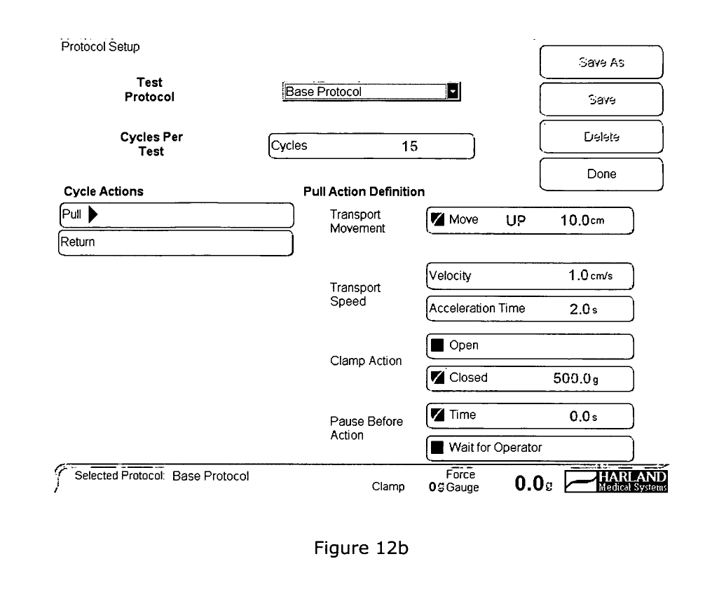

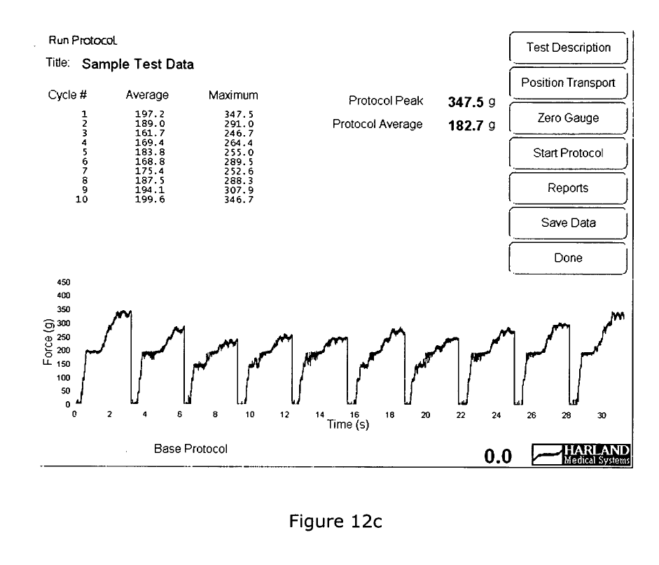

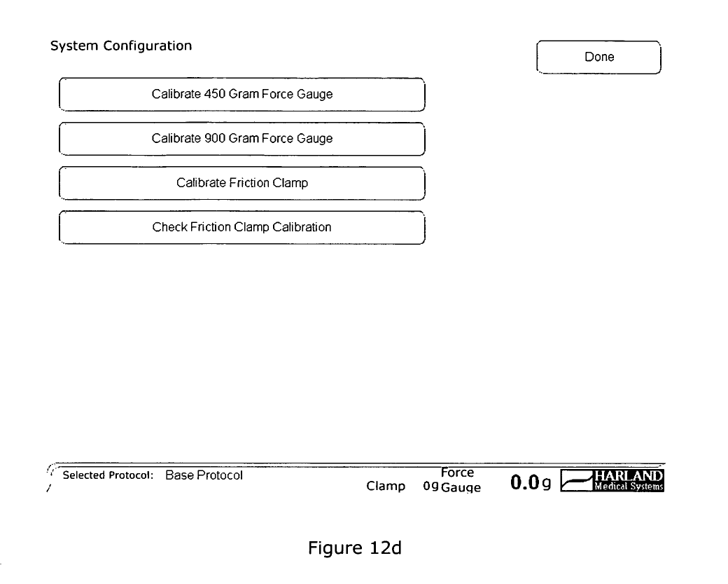

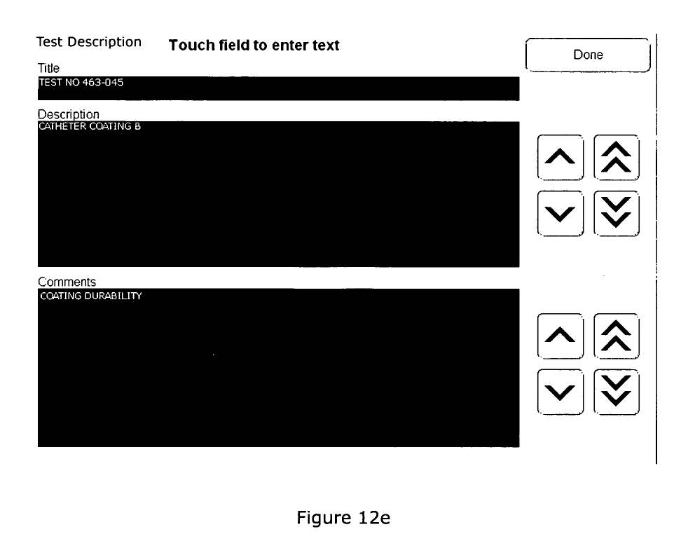

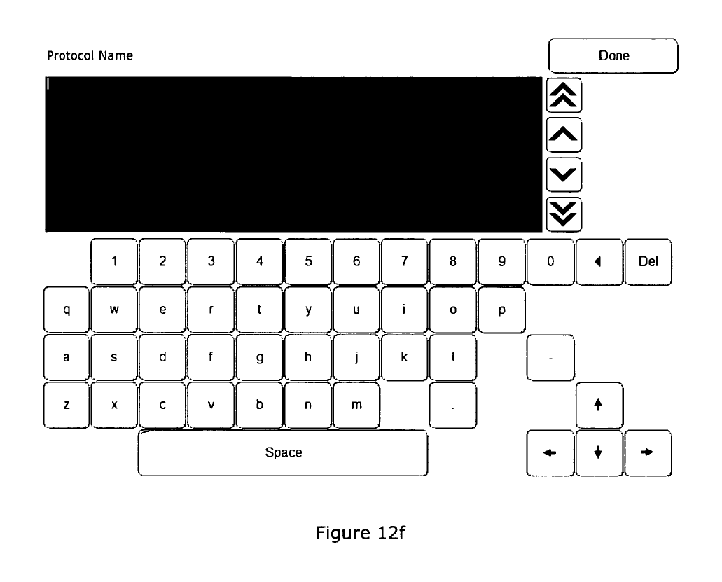

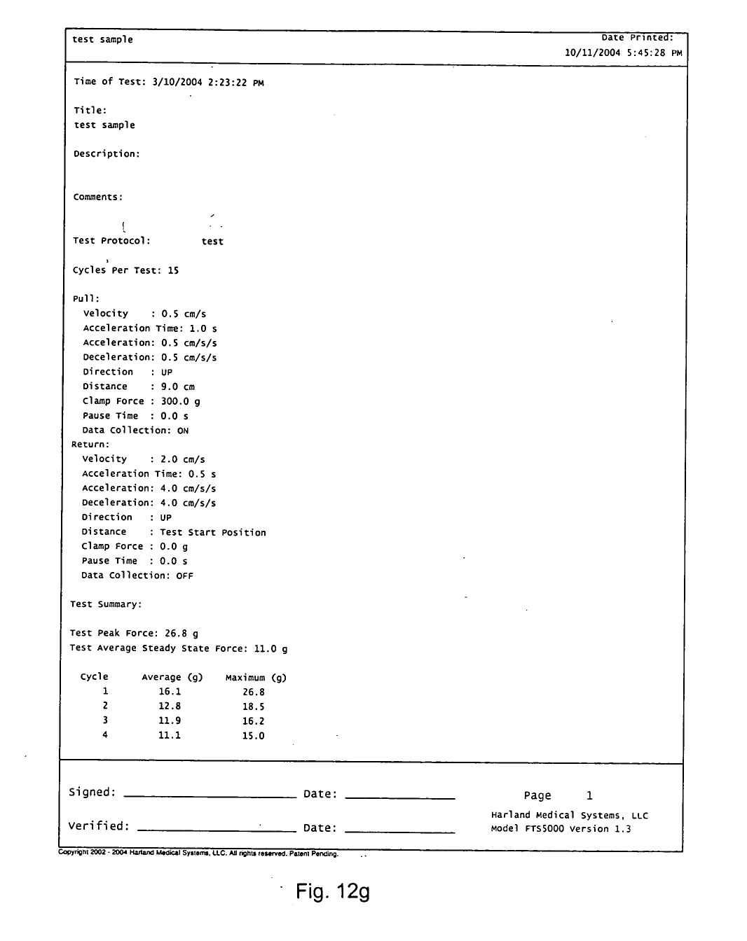

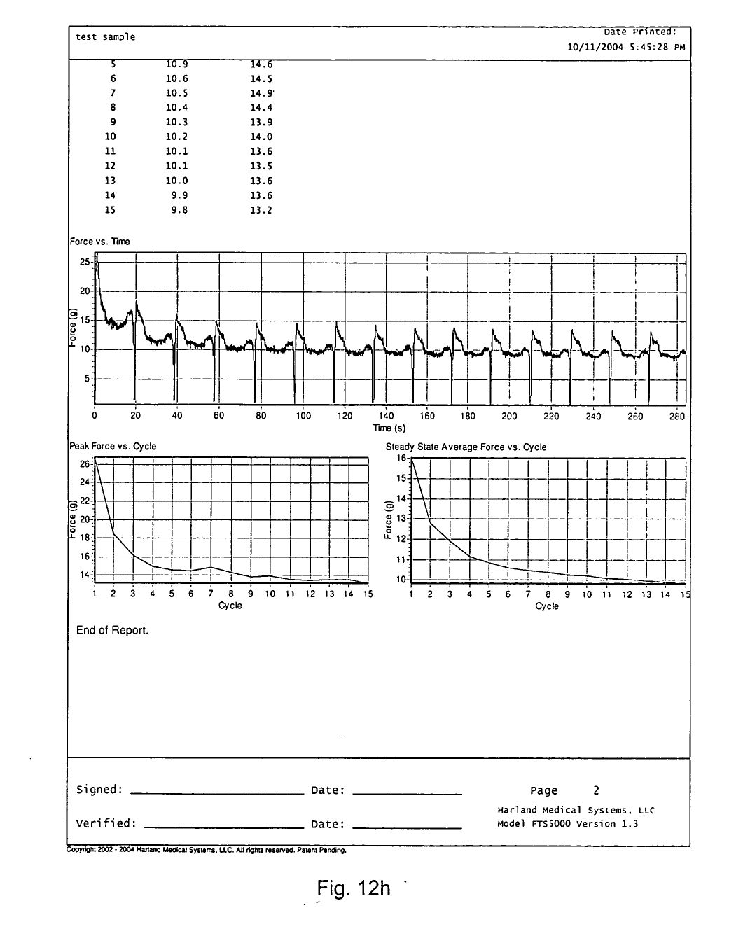

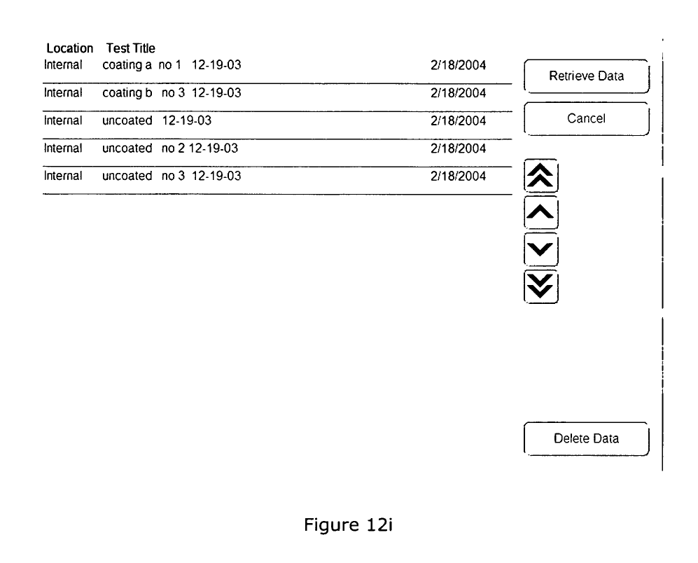

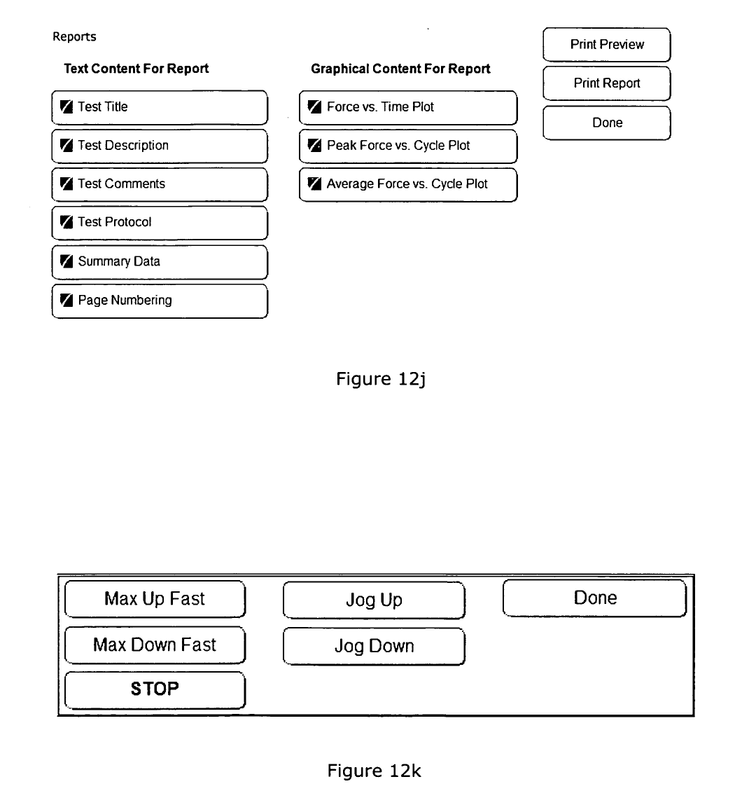

The method of configuring and operating the test apparatus through software is portrayed with reference to the user interface hierarchy map illustrated in FIG. 11. The Test Station Set Up screen, FIG. 12a, is displayed automatically after the test apparatus completes a power-on self test from when power is applied. From this screen the user may access the screens to configure the system or a protocol, run a test protocol, perform a soft shut down of the apparatus and reset fault messages and codes. Text to assist the user with steps to prepare for a test are displayed to the right of an illustration of the system apparatus. Control buttons for the force transducer transport and clamp module are at the bottom of the screen.

A test sample is next attached to the force module by a collet, hook or other means as described in more detail elsewhere. The Jog Up and Jog Down buttons are used to position the test sample within the clamp jaws. Once the test sample is positioned the Clamp Closed button is pressed and the jaws close to a predetermined nominal force that ensures that the test sample remains in position.

After positioning the test sample and clamp jaws the operator presses the Run Protocol button. From the Run Protocol screen, FIG. 12c, the operator can immediately begin executing the test protocol by pressing the Start Protocol button. The test protocol performs each test cycle automatically and graphs pull force values with time at the bottom of the screen. Clamp force values corresponding to the same time scale may also be graphed at the bottom of the screen. Also displayed on the screen are average and maximum pull force recorded during each completed test cycle, a running average of pull force recorded during the protocol and the peak pull force sample encountered across all cycles. The title of the test is displayed at the top of the screen sample

A status bar is displayed at the bottom of most screens. The status bar always displays the name of the selected test protocol and current reading on the force gauge. Other messages and values are displayed in the status bar to assist the operator. Messages include “Transport” for a transport move or communications error, “Calibrate” and “Calibrate-clamp” when there has been an error in calibration, “Data Acq”, and “Clamp”.

From the Run Protocol screen the operator may select other functions from the button along the right side of the screen. These buttons are generally ordered in the sequence most commonly accessed by the operator.

The Test Description brings up the screen illustrated in FIG. 12e. On this screen the operator may enter a name for the test that, for example, describes the sample and type of test. The operator may also enter a more detailed description of the test and comments in the larger entry areas below the title. Buttons located to the right of the entry areas and labeled with single or double arrows enable the operator to scroll up or down by lines or pages, respectively. Pressing Done exits the Test Description screen and returns to the Run Protocol screen. If the operator does not enter a test title the system automatically creates a title from the date and time the test begins.

To enter text on any screen the operator presses the text entry area to bring up the simulated keyboard screen illustrated in FIG. 12f. Pressing any of the labeled letter, number of symbol keys enters the text in the entry area. Pressing either Shift button toggles the screen between entry of lower and upper case characters (the images on the keys shift to show the selected case appearance). To reduce errors the simulated keyboard is sensitive to the type of text to be entered. For example, when entering a test title, which will become a file name, the keyboard does not display characters that are reserved by the test apparatus operating system.

Test protocols, file names and descriptive text may also be entered, reviewed or revised interactively by an external computer or keyboard connected to a port, such as USB or Ethernet, in communication with the SBC.

Pressing the Position Transport button on the Run Protocol screen displays a pop-up screen similar to the arrangement of buttons at the bottom of the Test Station Setup screen that are used to move the force module transport. Pressing Done on the pop-up returns to the Run Protocol screen.

The Zero Gauge action causes the computer to record an average of force gauge values for several seconds and store that average as the zero reference. The screen automatically returns to the original Run Protocol screen when zeroing is complete. The operator must ensure that the force gauge is unloaded during zeroing and then proceed through the steps to prepare the test sample for the test protocol.

The Save Data button displays a screen, FIG. 12i, that allows the operator to access completed test protocols stored within the test apparatus or externally. The list of stored reports shows the location (either internal or external, or the folder name), the test title and the date the test was run. Touching any of the report listings displays the contents of the report in a screen similar to FIGS. 12g and 12h. A Test Report Configuration screen (not shown) allows the operator to select which data and fields are display on printed reports (all data are recorded in the binary file).

By pressing the Save Data button the operator is given the opportunity to choose the location where the test data files will be stored. If the operator attempts to begin a new test protocol or load data from a completed test a prompt window appears asking if the operator would like to save unsaved data before continuing.

From the Test Station Setup screen the operator may also choose to configure the test protocol by pressing the Setup Protocol button. The screen displayed will be similar to that in FIG. 12b. From the drop-down list box at the top of the screen the operator may choose any saved protocol to load into the apparatus. The Base Protocol is the default test protocol and can not be erased. All other protocols may be saved or modified in non-volatile internal memory or erased at will. Modified protocols may also be saved with a new name by pressing the New button. Access to saved test protocol configurations may be controlled through the use of a password protection algorithm. Additional CRC data may be embedded with the saved protocol for use in determining if the saved protocol configuration has been corrupted. Protocols that have been corrupted are not loaded into the system.

The protocol is configured by the several buttons in the center and right of the Test Protocol Setup screen. Parameters that can be entered include the number of cycles to be run in the protocol, the steady-state velocity, the acceleration to the steady-state velocity, the deceleration to stop, the move direction (up or down), the Pre-action Pause duration, and the status of data collection (generally always on). Under Distance the operator can set the starting position of the force module transport at the beginning of the move. Top and Bottom mean the upper or lower limits of the tower (Top can only be selected for a downward move and vice versa). Cycle Start Position means starting from the manually positioned location of the force module transport. Relative means the start position is adjusted to the input distance relative to Top, Bottom or Cycle Start positions as selected. The clamp force is set after pressing the Closed button and the clamp can be opened by pressing the Open button. From the Test Protocol Setup screen the operator may directly run a test protocol by pressing the Perform Test button or return to the Test Station Setup screen.

Pressing System Configuration displays the screen illustrated in FIG. 12d. The force gauge, clamp force and distance units may be independently set to any of several metric, US and imperial units by touching the appropriate list box. Alternatively, the operator can select a master units list (not shown) that sets all three data parameters to the same units system (e.g. SI, MKS, cgs, US and imperial). The Fast Move Velocity and Job Velocity can be configured by pressing the appropriate button.

The operator can perform two-point or higher order calibrations of both the force and clamp transducers by pressing the respective Calibrate button. Calibrations are made by placing or suspending known masses on the force transducers. Calibration data are stored by the SBC and used in combination with linearization information and other characteristics of the force transducers read from the EEPROM to provide an accurate force in engineering units. The touch panel display may also be calibrated.

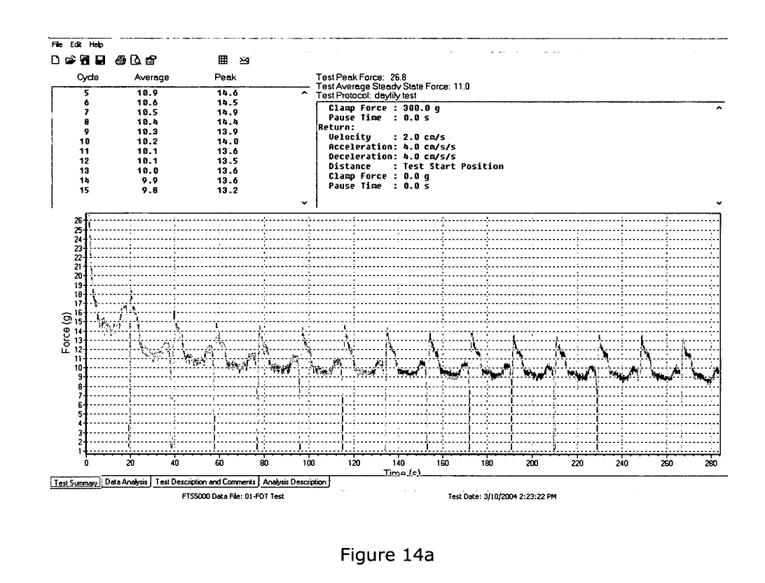

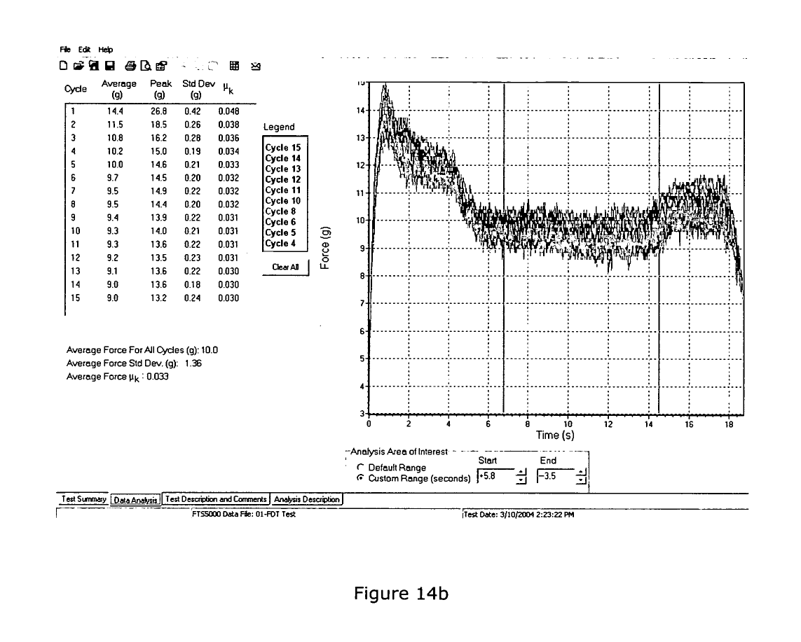

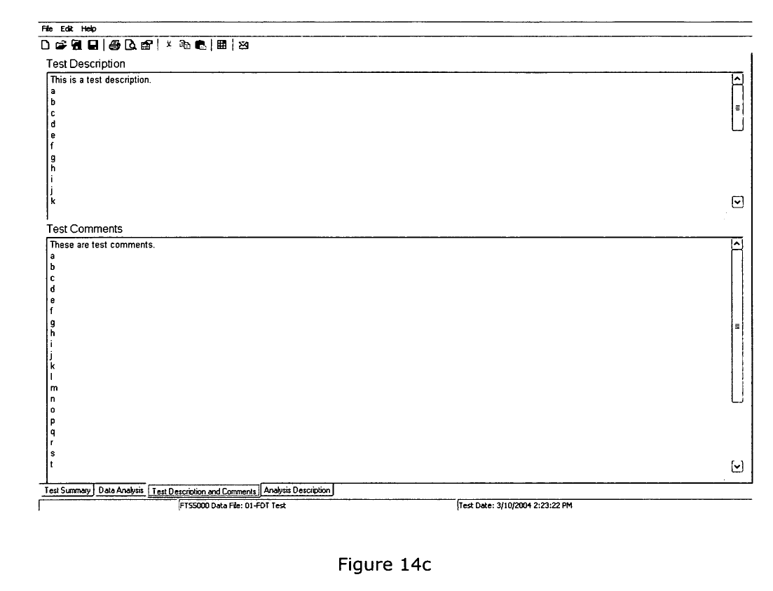

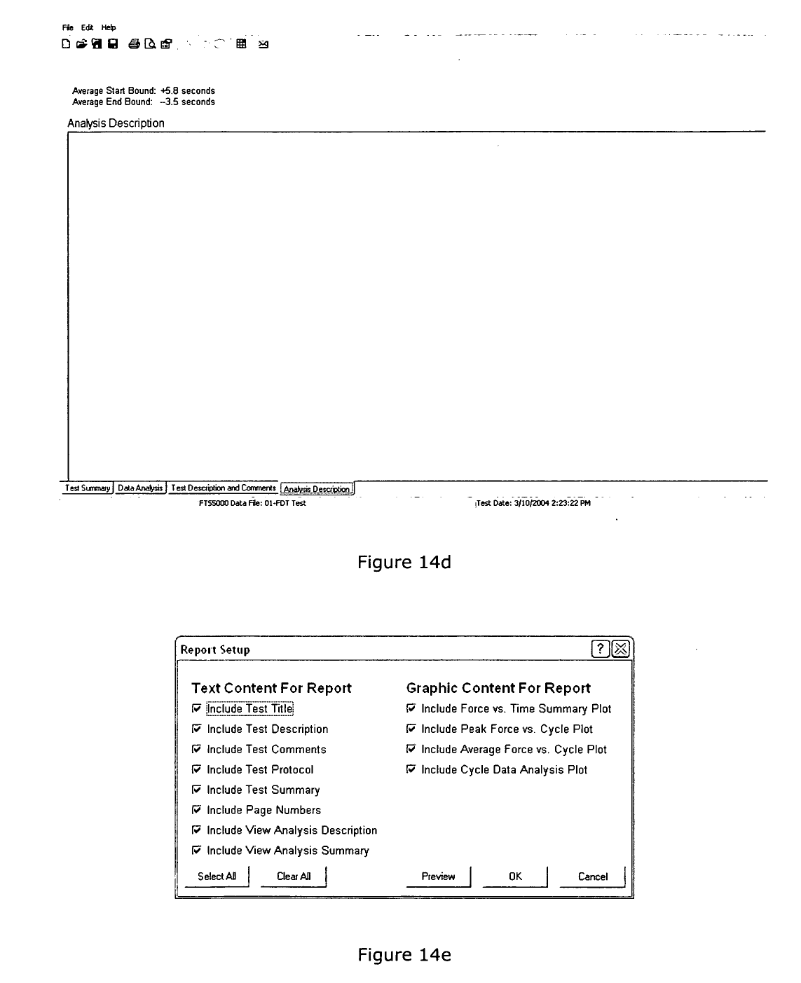

FIGS. 14a to 14d are user interface screens a representative embodiment of a data viewer application to be used with the invention. The viewer application provides means of viewing the data files created by the invention and performing analysis functions away from the invention on a desktop computer. The view application allows the user to view the test data and select areas of interest for which data averages, peaks, standard deviations and coefficient of friction calculations may be performed and displayed, saved, or printed in a report. The viewer application also utilizes CRC data embedded in the data files created by the invention to detect corrupted data.

The foregoing examples demonstrate exemplary features of the present invention, it will be apparent to those skilled in the art that a number of changes to the preferred embodiments may be made while still remaining within the scope of the invention and its equivalents, as set forth below in the claims.

What is claimed:

1. A surface characterization system comprising:
a first force transducer mounted to a motion device;
a sample holder mounted to the first force transducer that holds a sample for surface testing;
at least one test surface;
a loading device that applies a force on the sample through the at least one test surface;
a second force transducer that measures the force applied to the sample by the loading device;
one or more processors that control the motion device and the loading device;
wherein at least one processor controls the motion device to cause relative movement between the sample and the test surface; and
wherein at least one processor controls the loading device to apply a predetermined force to the sample through the test surface.

2. The surface characterization system of claim 1, wherein the processor uses a signal from the second force transducer for feedback control to cause the loading device to apply a substantially constant force on the sample.

3. The surface characterization system of claim 1, wherein the processor uses a signal from the first force transducer for feedback control of the motion of the sample relative to the test surface.

4. The surface characterization system of claim 1, wherein the processor controls the motion device to move in a predetermined velocity profile.

5. The surface characterization system of claim 4, wherein the predetermined velocity profile comprises an acceleration phase, a substantially constant velocity phase and a deceleration phase.

6. The surface characterization system of claim 5, wherein force measured by either or both of the first or second force transducers during the substantially constant velocity phase is analyzed to determine surface characteristics of the sample.

7. The surface characterization system of claim 5, wherein the acceleration and deceleration phases of the velocity profile are configured to reduce the elastic effect of force applied to the sample.

8. A surface characterization system comprising:
a first force transducer mounted to a transport module;
at least one test surface;
a drive system that causes relative movement between the transport module and the test surface;
a second force transducer that measures force applied to the test surface in a direction normal to the test surface;
a processor-controlled loading device that uses a feedback signal from the second force transducer to apply a predetermined force to engage a sample with the test surface in a direction normal to the test surface;
a sample holder mounted to the force transducer that holds the sample in a position for frictional engagement with the test surface during the relative movement between the transport module and the test surface; and
wherein force measured by the first force transducer during the relative movement between the transport module and the test surface is indicative of frictional force resisting movement of the sample thereby characterizing the surface of the sample.

9. The surface characterization system of claim 8, wherein a processor-controlled motor rotates a lead screw for moving the transport module in a predetermined velocity profile.

10. The surface characterization system of claim 9, wherein forces measured during a substantially constant velocity phase of the predetermined velocity profile is analyzed to determine surface characteristics of the sample.

11. The surface characterization system of claim 8, wherein a processor-controlled motor turns a drive wheel that engages a drive belt attached to the transport module to move the transport module in a predetermined velocity profile.

12. The surface characterization system of claim 8, wherein the test surface is disengaged from the sample while the transport module is returned from a final position to a start position so that multiple test cycles may be performed on the sample.

13. The surface characterization system of claim 12, wherein at least 5 test cycles are performed on the sample.

14. The surface characterization system of claim 8, further comprising a container of fluid from which the sample is withdrawn during a test procedure.

15. The surface characterization system of claim 14, wherein the test surface is immersed in the container of fluid.

16. The surface characterization system of claim 14, wherein the container of fluid is maintained at a predetermined temperature.

17. The surface characterization system of claim 16, wherein the predetermined temperature is between 35° C. and 42° C.

18. The surface characterization system of claim 14, wherein the container of fluid is stirred.

19. The surface characterization system of claim 14, wherein the fluid is water, saline, aqueous buffer or albumin solution.

20. A method of characterizing a surface, said method comprising:
applying a substantially constant force to engage a sample and a test surface with a processor-controlled loading device;
moving the sample relative to the test surface at a predetermined velocity profile; and
measuring the force required to move the sample relative to the test surface.

21. The method of claim 20, further comprising the steps of:
filtering the force measurements with a low-pass, digital filter algorithm; and
averaging together the force measurements.

22. The method of claim 20, further comprising the steps of:
moving the sample past the test surface from a start position to a final position at the predetermined velocity profile;
disengaging the test surface from the sample at the final position;
returning the sample to the start position;
reengaging the sample and test surface;
re-applying the predetermined force between the sample and test surface; and
repeating the above steps for a predetermined number of cycles.

23. The method of claim 23, further comprising the step of pausing for a predetermined time between the steps of returning and reengaging.

24. The method of claim 23, wherein the predetermined number of cycles is at least 5.

25. A method of characterizing the surface of a sample by measuring friction between a sample and a test surface with the system of claim 8, said method comprising the steps of:
mounting a sample in the sample holder;
applying a predetermined force to engage the sample and the test surface; and
measuring the force required to move the sample past the test surface at a predetermined velocity profile.
